(19) United States
(12) Patent Application Publication
(10) Pub. No.: US 2013/0235018 A1
(43) Pub. Date: Sep. 12, 2013

(54) ELECTROPHORESIS DISPLAY APPARATUS

(71) Applicant: Sakae TANAKA, Suwon-si (KR)

(72) Inventor: Sakae TANAKA, Suwon-si (KR)

(73) Assignee: SAMSUNG DISPLAY CO., LTD., YONGIN-CITY (KR)

(21) Appl. No.: 13/589,968

(22) Filed: Aug. 20, 2012

(30) Foreign Application Priority Data
Mar. 12, 2012 (KR) 10-2012-0025154

(51) Int. Cl. G09G 3/34; G06F 3/038

(52) U.S. Cl. 345/212; 345/107

(57) ABSTRACT

An electrophoresis display apparatus includes a plurality of pixels. Each pixel includes a boost capacitor including a pixel electrode and a storage electrode a thin film transistor configured to apply a data voltage to the pixel electrode in response to a gate signal. A level of a storage voltage applied to the storage electrode of the boost capacitor is configured to be changed after the data voltage is applied to the pixel electrode, and a voltage level of the pixel electrode is configured to be boosted by the boost capacitor from a level of the data voltage to a boosted voltage by the change in the level of the storage voltage.

### CROSS-REFERENCE TO RELATED APPLICATION

This U.S. non-provisional patent application claims priority under 35 U.S.C. §119 of Korean Patent Application No. 10-2012-0025154, filed on Mar. 12, 2012, the contents of which are hereby incorporated by reference.

### BACKGROUND

1. Field of Disclosure

The present disclosure relates to an electrophoresis display apparatus. More particularly, the present disclosure relates to an electrophoresis display apparatus capable of reducing a manufacturing cost thereof and improving a contrast ratio.

2. Description of the Related Art

In recent, various displays, such as a liquid crystal display, an organic light emitting diode display, an electro-wetting display, a plasma display, an electrophoresis display, etc., have been developed.

Among them, the electrophoresis display displays an image using an electrophoretic principle. The electrophoresis indicates a phenomenon that charged electrophoretic particles move by an electric field formed between a pair of electrodes. The electrophoresis display is a reflective type display that reflects or absorbs light provided from the outside thereof using electrophoretic particles to display the image, and thus the electrophoresis display does not need to have a separate light source. In addition, since the electrophoresis display does not include optional components, such as a polarizing plate, an alignment layer, a liquid crystal layer, etc., which is different from the liquid crystal display, the electrophoresis display has properties, such as thin thickness, lightweight, etc., when compared with the liquid crystal display.

The electrophoresis display offers advantages in terms of high-reflectivity, high-contrast ratio, no viewing-angle dependence, low power consumption, etc. However, the electrophoresis display requires high cost data driver ICs having a high output voltage. Also, electrophoretic particles do not accumulated in a center of pixel due to weak electric field in the center of a pixel.

### SUMMARY

The present disclosure provides an electrophoresis display apparatus capable of reducing a manufacturing cost thereof.

The present disclosure provides an electrophoresis display apparatus capable of improving a contrast ratio of an image displayed thereon.

The present disclosure provides an electrophoresis display apparatus capable of displaying various intermediate gray scales.

Embodiments of the inventive concept provide an electrophoresis display apparatus includes a display panel that includes a plurality of pixels, a gate driver that is configured to sequentially apply gate signals to the pixels through a plurality of gate lines, a storage driver that is configured to sequentially apply storage voltages to the pixels through a plurality of storage lines, and a data driver that is configured to apply data voltages to the pixels through a plurality of data lines. Each of the pixels includes a boost capacitor including a pixel electrode and a storage electrode branched from a corresponding storage line of the storage lines and a thin film transistor configured to apply a corresponding data voltage of the data voltages to the pixel electrode in response to a corresponding gate signal of the gate signals. A level of the storage voltage is configured to be changed after the corresponding data voltage is applied to the pixel electrode, and a voltage level of the pixel electrode is configured to be boosted by the boost capacitor from a level of the corresponding data voltage to a boosted voltage by the change in the level of the storage voltage.

The storage voltage includes a first storage voltage and a second storage voltage having a level higher than a level of the first storage voltage, and the data voltage includes a first data voltage at a positive polarity and a second data voltage at a negative polarity.

The storage electrode is configured to be applied with the first storage voltage while the first data voltage is applied to the pixel electrode, and the storage electrode is configured to be applied with the second storage voltage after the first data voltage is applied to the pixel electrode. The voltage level of the pixel electrode is configured to be increased by the boost capacitor from the first data voltage to a boosted voltage by a level difference between the first and second storage voltages, and the pixel is configured to display a white gray scale corresponding to the voltage level of the pixel electrode.

The storage electrode is configured to be applied with the second storage voltage while the second data voltage is charged to the pixel electrode, and the storage electrode is configured to be applied with the first storage voltage after the second data voltage is charged to the pixel electrode. The voltage level of the pixel electrode is configured to be decreased by the boost capacitor from the second data voltage to a boosted voltage by the level difference between the first and second storage voltages, and the pixel is configured to display a black gray scale corresponding to the voltage level of the pixel electrode.

The thin film transistor includes a gate electrode connected to a corresponding gate line of the gate lines, a source electrode connected to a corresponding data line of the data lines, and a drain electrode connected to a connection electrode branched from the pixel electrode.

The pixel electrode includes a first area formed in a center area of the pixel electrode, a plurality of first branch portions extended from the first area toward an each vertex of the pixel electrode, and a plurality of second branch portions protruded from the first area toward each edges of the pixel electrode. The connection electrode is branched from the first branch portions or the second branch portions.

The display panel includes a first base substrate on which the thin film transistor, the storage electrode, the pixel electrode an insulating layer formed on the pixel electrode, and a barrier wall electrode disposed on the insulating layer to partition the pixels are disposed, a second base substrate facing the first base substrate and including a resist electrode disposed thereon and applied with the first data voltage, and an electrophoretic material interposed between the first and second base substrates and accommodated in a pixel area defined by the barrier wall electrode. The pixel electrode is connected to the drain electrode of the thin film transistor and overlapped with the storage electrode to form the boost capacitor, and the electrophoretic material includes dielectric solvent and electrophoretic particles, which have a black color and are distributed in the dielectric solvent and charged to a positive electric charge.

The storage voltage is configured to be maintained in the first storage voltage while the first data voltage is applied to the pixel electrode, the storage voltage is configured to be changed to the second storage voltage after the first data voltage is applied to the pixel electrode, and the electrophoretic particles is configured to move to the barrier wall electrode by an electric field generated between the pixel electrode and the barrier wall electrode and between the resist electrode and the barrier wall electrode.

The storage voltage is configured to be maintained in the second storage voltage while the second data voltage is applied to the pixel electrode, the storage voltage is configured to be changed to the first storage voltage after the second data voltage is applied to the pixel electrode, and the electrophoretic particles is configured to move onto the pixel electrode by an electric field generated between the pixel electrode and the barrier wall electrode.

Embodiments of the inventive concept provide an electrophoresis display apparatus includes a display panel that includes a plurality of pixels, a gate driver that is configured to sequentially apply gate signals to the pixels through a plurality of gate lines including first gate lines and second gate lines, a storage driver that is configured to be sequentially apply storage voltages to the pixels through a plurality of storage lines, and a data driver that is configured to apply data voltages to the pixels through a plurality of data lines. Each of the pixels includes a first pixel electrode disposed in a center area of the pixel, a second pixel electrode spaced apart from the first pixel electrode and formed to surround the first pixel electrode, a first boost capacitor including the first pixel electrode and a storage electrode branched from a corresponding storage line of the storage lines, a second boost capacitor including the second pixel electrode and the storage electrode, a first thin film transistor configured to apply a corresponding data voltage of the data voltages to the first pixel electrode in response to a corresponding gate signal of the gate signals provided through the first gate line, and a second thin film transistor configured to apply a corresponding data voltage of the data voltages to the second pixel electrode in response to a corresponding gate signal of the gate signals provided through the second gate line. A level of the storage voltage is configured to be changed after the corresponding data voltage is applied to the first and the second pixel electrodes, and a voltage level of the first and the second pixel electrodes is configured to be boosted by the first and the second boost capacitors from a level of the corresponding data voltage to a boosted voltage by the change in the level of the storage voltage.

According to the above, the electrophoresis display apparatus may be operated by using the data driver at the low prices, so that the manufacturing cost of the electrophoresis display apparatus may be reduced.

In addition, the electrophoresis display apparatus may display the black gray scale normally, and thus the contrast ratio of the image displayed on the electrophoresis display apparatus may be improved.

In addition, the electrophoresis display apparatus may display various intermediate gray scales.

### BRIEF DESCRIPTION OF THE DRAWINGS

The above and other advantages of the present invention will become readily apparent by reference to the following detailed description when considered in conjunction with the accompanying drawings wherein:

FIG. 1 is a block diagram showing an electrophoresis display apparatus according to a first exemplary embodiment of the present invention;

FIG. 2 is a plan view showing a pixel shown in FIG. 1;

FIG. 3 is a layout showing a pixel shown in FIG. 1;

FIG. 4 is a cross-sectional view taken along a line I-I′ shown in FIG. 3;

FIG. 5 is a cross-sectional view taken along a line II-II′ shown in FIG. 3;

FIG. 6 is a cross-sectional view taken along a line III-III′ shown in FIG. 3;

FIG. 7A is a waveform diagram showing a storage voltage applied to a pixel in order to display a white gray scale and a state of a voltage level state of a pixel electrode;

FIG. 7B is a waveform diagram showing a storage voltage applied to a pixel in order to display a black gray scale and a state of a voltage level state of a pixel electrode;

FIG. 8A is a cross-sectional view showing a movement of electrophoretic particles of a pixel in accordance with the storage voltage and the voltage level of the pixel electrode shown in FIG. 7A;

FIG. 8B is a cross-sectional view showing a movement of electrophoretic particles of a pixel in accordance with the storage voltage and the voltage level of the pixel electrode shown in FIG. 7B;

FIG. 9 is a cross-sectional view showing electrophoretic particles in adjacent pixels to each other among pixels shown in FIG. 1, which respectively display a black gray scale and a white gray scale;

FIGS. 10A and 10B are cross-sectional views showing a pixel of an electrophoresis display apparatus according to a second exemplary embodiment of the present invention;

FIG. 11 is a cross-sectional view showing electrophoretic particles in adjacent pixels to each other among pixels according to the second exemplary embodiment of the present invention, which respectively display a black gray scale and a white gray scale;

FIG. 12 is a block diagram showing an electrophoresis display apparatus according to a third exemplary embodiment of the present invention;

FIG. 13 is a plan view showing a pixel shown in FIG. 12;

FIG. 14 is a layout showing a pixel shown in FIG. 12;

FIG. 15 is a cross-sectional view taken along a line II-II′ shown in FIG. 14;

FIG. 16 is a cross-sectional view taken along a line II1-II1′ shown in FIG. 14;

FIGS. 17A to 17D are cross-sectional views taken along a line II2-II2′ shown in FIG. 14;

FIG. 18 is a plan view showing a pixel of an electrophoresis display apparatus according to a fourth exemplary embodiment of the present invention;

FIG. 19 is a plan view showing a pixel of an electrophoresis display apparatus according to a fifth exemplary embodiment of the present invention;

FIG. 20 is a layout showing a pixel shown in FIG. 19;

FIG. 21 is a cross-sectional view taken along a line III-III′ shown in FIG. 20;

FIG. 22 is a cross-sectional view taken along a line III1-III1′ shown in FIG. 20;

FIG. 23 is a plan view showing a pixel of an electrophoresis display apparatus according to a sixth exemplary embodiment of the present invention;

FIG. 24 is a plan view showing a pixel of an electrophoresis display apparatus according to a seventh exemplary embodiment of the present invention;

FIG. 25 is a plan view showing a pixel of an electrophoresis display apparatus according to an eighth exemplary embodiment of the present invention;

FIG. 26 is a plan view showing a pixel of an electrophoresis display apparatus according to a ninth exemplary embodiment of the present invention; and

FIG. 27 is a plan view showing a pixel of an electrophoresis display apparatus according to a tenth exemplary embodiment of the present invention.

### DETAILED DESCRIPTION

Hereinafter, the present invention will be explained in detail with reference to the accompanying drawings.

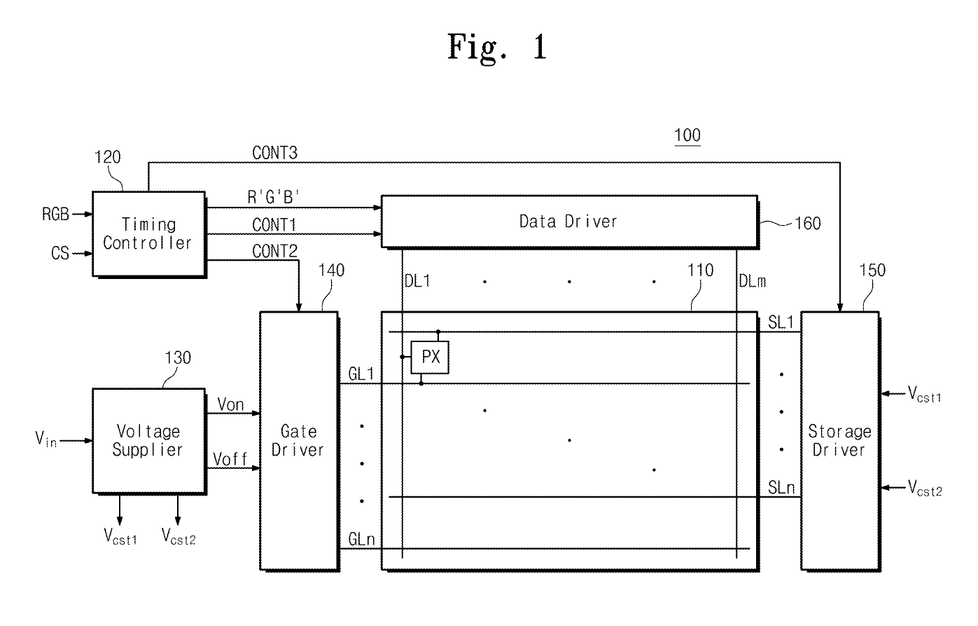

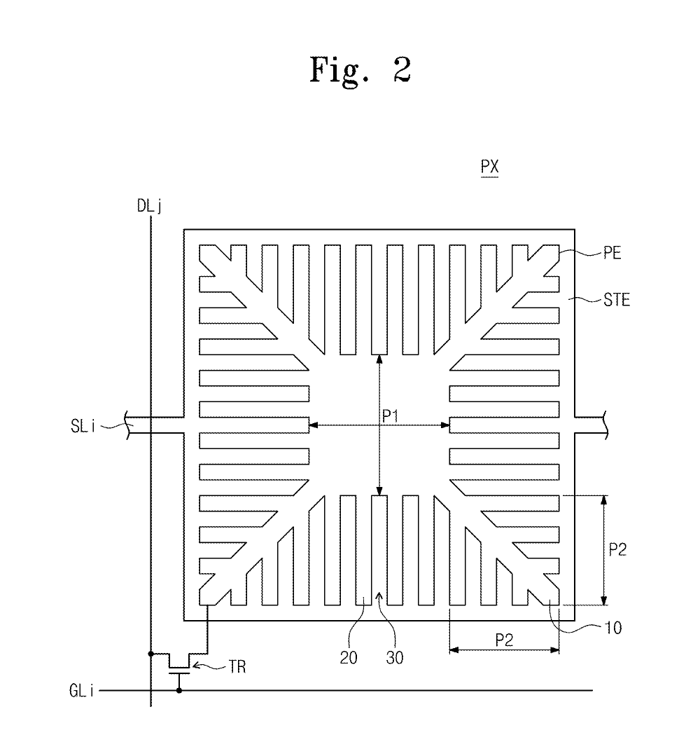

FIG. 1 is a block diagram showing an electrophoresis display apparatus according to a first exemplary embodiment of the present invention and FIG. 2 is a plan view showing a pixel shown in FIG. 1. In the present exemplary embodiment, since pixels in the electrophoresis display apparatus have the same configuration and function, for the convenience of explanation, only one pixel has been shown in FIG. 1.

Referring to FIGS. 1 and 2, an electrophoresis display apparatus 100 includes a display panel 110, a timing controller 120, a voltage supplier 130, a gate driver 140, a storage driver 150, and a data driver 160.

The display panel 110 includes a plurality of gate lines GL1 to GLn, a plurality of storage lines SL1 to SLn substantially parallel to the gate lines GL1 to GLn, a plurality of data lines DL1 to DLm crossing the gate lines GL1 to GLn, and a plurality of pixels PX arranged in association with the gate lines GL 1 to GLn and the data lines DL 1 to DLm. The pixels PX are arranged in a matrix form of n row by m columns. Each of n and m is a constant number larger than zero (0). For the convenience of explanation, one pixel PX has been shown in FIG. 1.

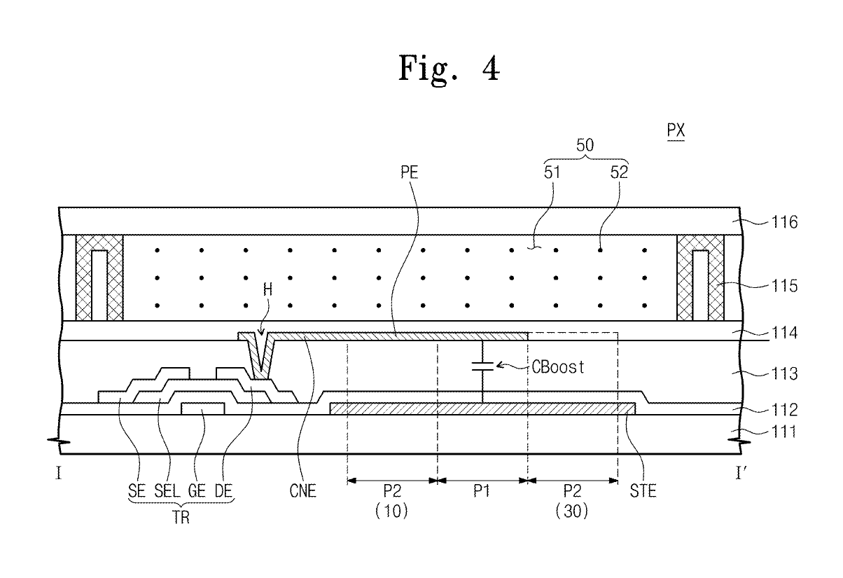

Each pixel PX is connected to a corresponding gate line (e.g., GLi) of the gate lines GL1 to GLn and a corresponding data line (e.g., DLj) of the data lines DL1 to DLm. Each pixel PX includes a thin film transistor TR, a pixel electrode PE connected to the thin film transistor TR, a storage electrode STE branched from a corresponding storage line (e.g., SLi) of the storage lines SL1 to SLn, and a boost capacitor formed by the pixel electrode PE and the storage electrode STE. The boost capacitor will be described in detail with reference to FIGS. 4 to 6 later.

The thin film transistor TR includes a gate electrode connected to the corresponding gate line GLi, a source electrode connected to the corresponding data line DLi, and a drain electrode connected to the pixel electrode PE.

The pixel electrode PE includes a first area P1 having a rectangular shape and disposed at a center portion thereof, a plurality of first branch portions 10 protruded from each vertex of the first area P1, and a plurality of second branch portions 20 protruded from four sides of the first area P1 and the first branch portions 10. Areas between the second branch portions 20 may be defined as slit areas 30. In addition, an area of the pixel electrode PE, which includes the first branch portions 10, the second branch portions 20, and the slit areas 30, may be defined as a second area P2. The configuration of the pixel electrode PE may be defined as a feather pattern.

Although not shown in FIG. 1, the pixels PX are partitioned by a barrier wall electrode and further include an electrophoretic material accommodated in a pixel area defined by the barrier wall electrode. The electrophoretic material includes a dielectric solvent and a plurality of electrophoretic particles dispersed in the dielectric solvent.

Each of the electrophoretic particles is charged to have a positive (+) polarity or a negative (−) polarity and has a black color. However, each electrophoretic particle may have a red color, a blue color, a green color, or a white color. In the present exemplary embodiment, the electrophoretic particles are charged to the positive (+) polarity and have the black color.

The gate lines GL1 to GLn are connected to the gate driver 140 to receive gate signals. The storage lines SL1 to SLn are connected to the storage driver 150 to receive storage signals. The data lines DL 1 to DLm are connected to the data driver 160 to receive data voltages.

The timing controller 120 receives image signals RGB and control signals CS from an external device (not shown). The timing controller 120 converts a data format of the image signals RGB into a data format appropriate to an interface between the data driver 160 and the timing controller 120 and provides the converted image signals R′G′B′ to the data driver 160.

In addition, the timing controller 120 generates a data control signal CONT1, a gate control signal CONT2, and a storage control signal CONT3 in response to the control signal CS. The timing controller 120 applies the data control signal CONT1, the gate control signal CONT2, and the storage control signal CONT3 to the data driver 160, the gate driver 140, and the storage driver 150, respectively.

The voltage supplier 130 receives an input voltage Vin from an external device (not shown) and converts the input voltage Vin to generate a gate-on voltage Von, a gate-off voltage Voff, a first storage voltage Vcst1, and a second storage voltage Vcst2. The voltage supplier 130 applies the gate-on voltage Von and the gate-off voltage Voff to the gate driver 140 and applies the first storage voltage Vcst1 and the second storage voltage Vcst2 to the storage driver 150.

The gate driver 140 receives the gate-on voltage Von and the gate-off voltage Voff from the voltage supplier 130 and generates the gate signals. The gate driver 140 sequentially outputs the gate signals to the gate lines GL 1 to GLn in response to the gate control signal CONT2.

The storage driver 150 receives the first storage voltage Vcst1 and the second storage voltage Vcst2 from the voltage supplier 130 and generates the storage signals. The storage driver 150 sequentially applies the storage signals to the storage lines SL1 to SLn in response to the storage control signal CONT3 from the timing controller 120. Accordingly, the storage signals are respectively applies to the storage electrodes STE branched from the storage lines SL1 to SLn. The first storage voltage Vcst1 has a level lower than a level of the second storage voltage Vcst2.

The data driver 160 converts the converted image signals R′G′B′ into the data voltages (or data signals) in response to the data control signal CONT1 from the timing controller 120 and applies the data voltages to the data lines DL1 to DLm.

Each pixel PX is applied with a corresponding data voltage of the data voltages in response to a corresponding gate signal of the gate signals. In detail, when the gate signals are sequentially applied to the gate lines GL1 to GLn, each thin film transistor TR connected to the corresponding gate line of the gate lines GL1 to GLn is turned on. The data voltage is applied to the pixel electrode PE through the turned-on thin film transistor TR.

The data voltages may include a positive (+) first data voltage used to display the white gray scale and a negative (−) second data voltage used to display the black gray scale.

In the case that the pixel PX displays the white gray scale, the storage signal may be maintained in the level of the first storage voltage Vcst1 while the first data voltage is applied to the pixel electrode PE. After the first data voltage is applied to the pixel electrode PE, the level of the storage signal may be changed to the level of the second storage voltage Vcst2 from the level of the first storage voltage Vcst1. That is, the level of the storage signal may be increased to the level of the second storage voltage Vcst2 from the level of the first storage voltage Vcst1.

When the voltage level of the storage electrode STE is changed, the voltage level of the pixel electrode PE is changed since the pixel electrode PE and the storage electrode STE form the boost capacitor. Thus, due to the boost capacitor, the voltage level of the pixel electrode PE is boosted up by a level difference between the first storage voltage Vcst1 and the second storage voltage Vcst2 from the first data voltage. As a result, the pixel PX displays the white gray scale corresponding to the voltage level of the pixel electrode PE boosted up by the boost capacitor.

In the case that the pixel PX displays the black gray scale, the storage signal may be maintained in the level of the second storage voltage Vcst2 while the second data voltage is applied to the pixel electrode PE. After the second data voltage is applied to the pixel electrode PE, the level of the storage signal may be changed to the level of the first storage voltage Vcst1 from the level of the second storage voltage Vcst2. In other words, the level of the storage signal may be decreased to the level of the first storage voltage Vcst1 from the level of the second storage voltage Vcst2.

Accordingly, due to the boost capacitor, the voltage level of the pixel electrode PE is boosted down by the level difference between the first storage voltage Vcst1 and the second storage voltage Vcst2 from the second data voltage. As a result, the pixel PX displays the black gray scale corresponding to the voltage level of the pixel electrode PE boosted down by the boost capacitor.

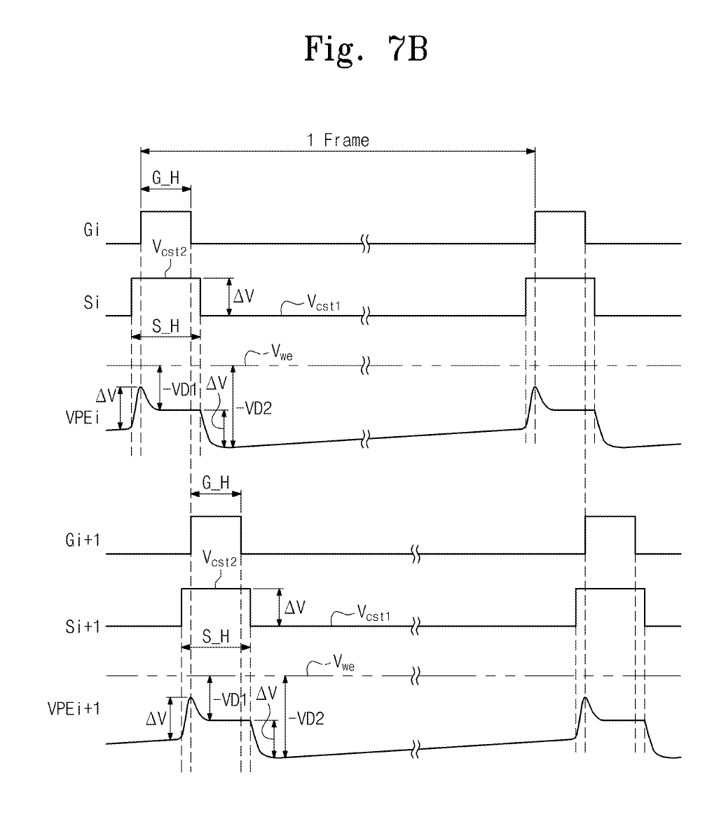

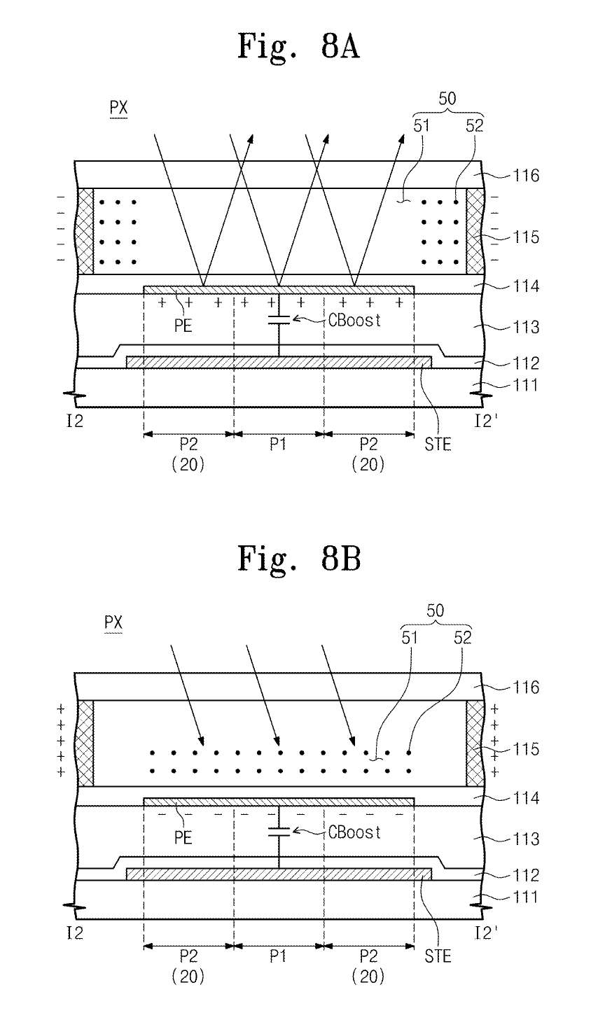

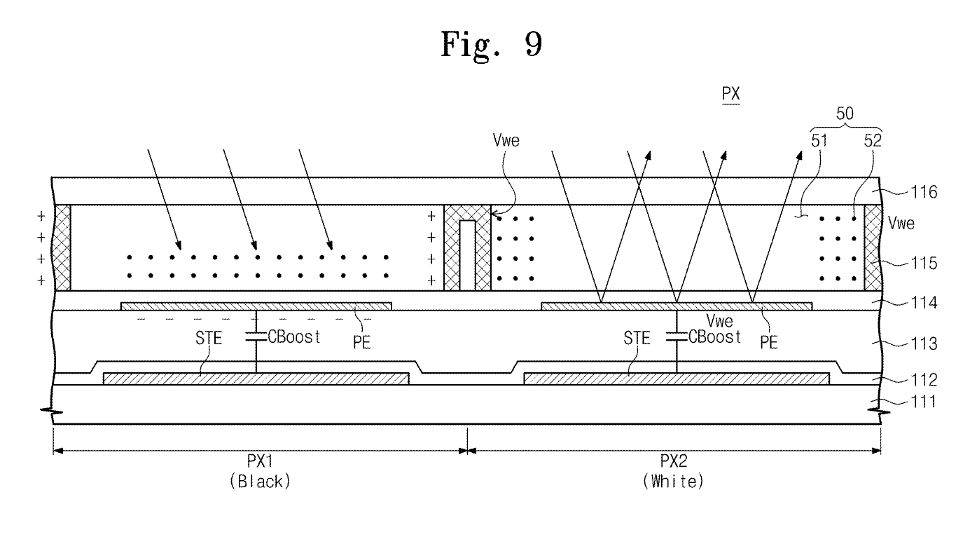

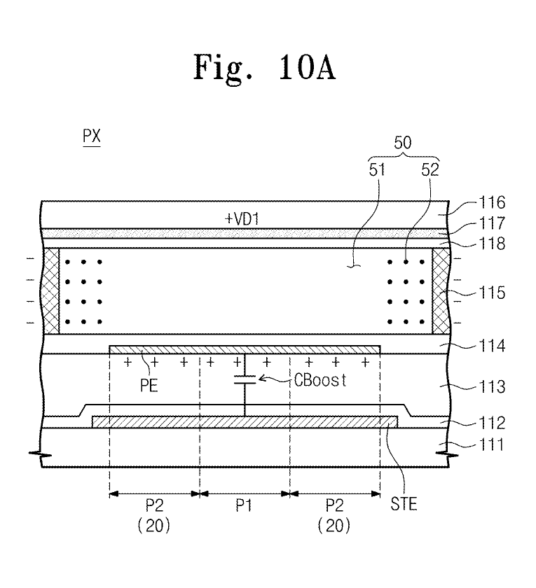

The operation of each pixel PX according to the application of the storage signal will be described in detail with reference to FIGS. 7A, 7B, 8A, and 8B later.

With reference to the configuration and the operation of the above-described electrophoresis display apparatus 100, the voltage level of the pixel electrode PE of each pixel PX is boosted up or boosted down to a boosted voltage by the boost capacitor. Thus, although the electrophoresis display apparatus 100 is operated using a low data voltage, the electrophoresis display apparatus 100 may be operated in the same way as when the electrophoresis display apparatus 100 is operated using a high data voltage. As an output voltage level of the data driver increases, a unit cost of data driver Integrated Circuit (hereinunder “IC”) becomes high. However, the electrophoresis display apparatus 100 according to the present exemplary embodiment offers the same performance of IC using the high voltage without using the high cost data driver IC. Consequently, a manufacturing cost of the electrophoresis display apparatus 100 may be reduced since the electrophoresis display apparatus 100 is operated using the low cost data driver.

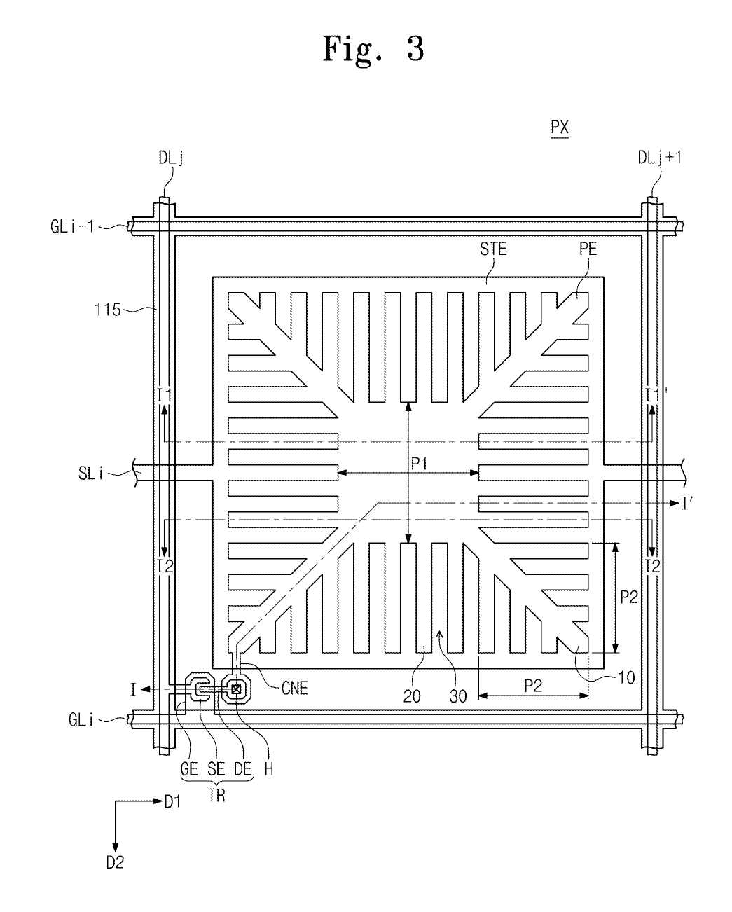

FIG. 3 is a layout showing a pixel shown in FIG. 1. Since the pixels PX have the same configuration and function, one pixel has been shown in FIG. 3.

Referring to FIG. 3, the pixel PX includes the gate line GLi, the storage line SLi, the data line DLj, the thin film transistor TR, the pixel electrode PE, and the storage electrode STE. The i is a constant number lager than zero and equal to or smaller than n, and the j is a constant number larger than zero and equal to or smaller than m.

The gate line GLi is extended in a first direction D1 and the storage line SLi is extended substantially parallel to the gate line GLi. The data line DLj is extended in a second direction D2 substantially perpendicular to the first direction D1 and insulated from the gate line GLi and the storage line SLi while crossing the gate line GLi and the storage line SLi.

The thin film transistor TR includes a gate electrode GE branched from the gate line GLi, a source electrode SE branched from the data line DLj, and a drain electrode DE electrically connected to a connection electrode CNE branched from the pixel electrode PE through a contact hole H. The storage electrode STE is branched from the storage line SL.

The pixel electrode PE is formed to overlap with the storage electrode STE and the storage electrode STE has an area larger than that of the pixel electrode PE.

The configuration of the pixel electrode PE has been described already, details thereof will be omitted. The connection electrode CNE may be branched from one of the first branch portions 10 or one of the second branch portions 20. In the present exemplary embodiment, the connection electrode CNE is branched from one of the first branch portions 10 as shown in FIG. 3.

The barrier wall electrode 115 that partitions the pixels PX is formed along the gate lines GL 1 to GLn and the data lines DL 1 to DLm.

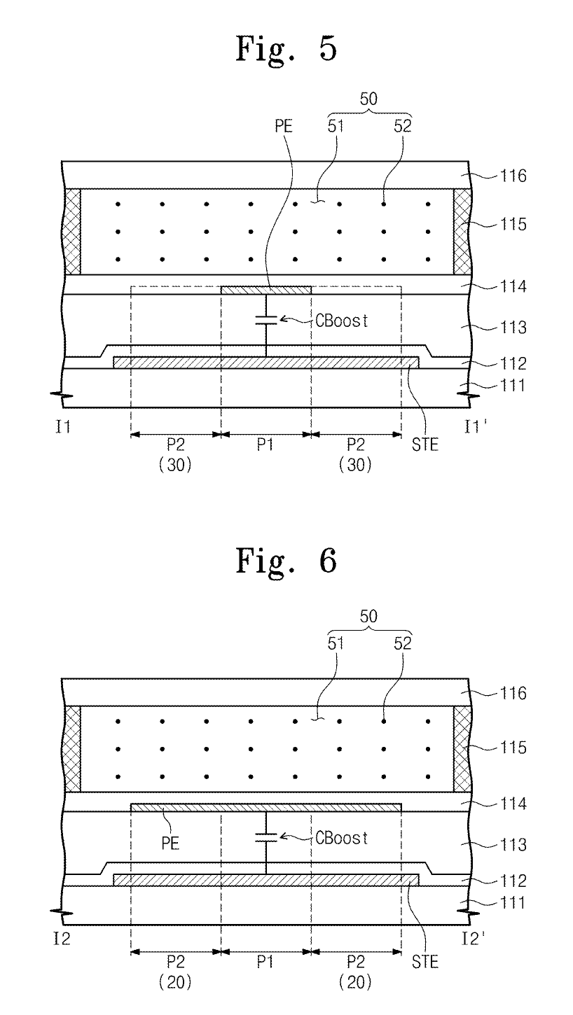

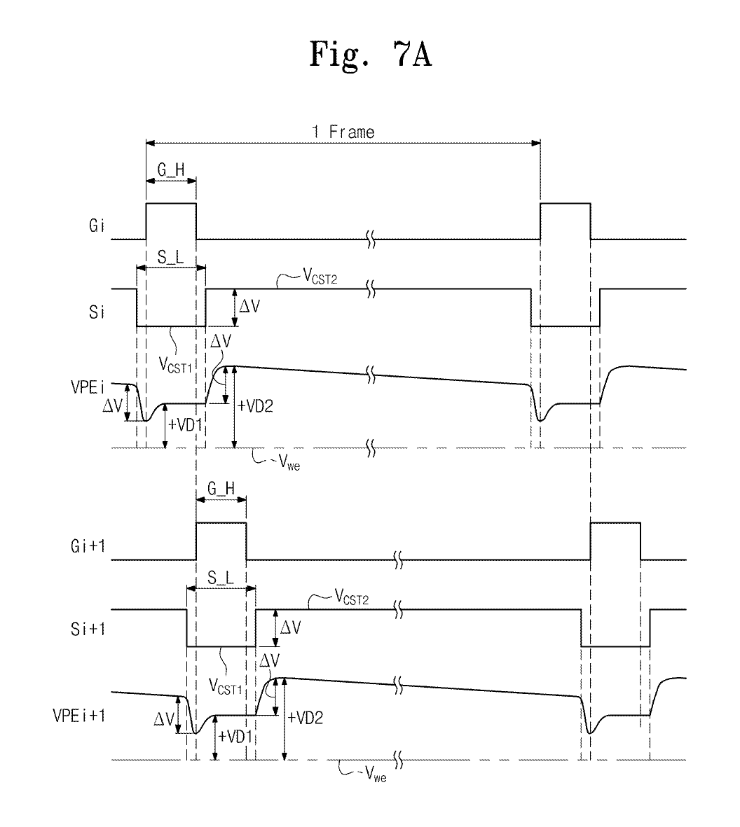

FIG. 4 is a cross-sectional view taken along a line I-I′ shown in FIG. 3, FIG. 5 is a cross-sectional view taken along a line II-II′ shown in FIG. 3, and FIG. 6 is a cross-sectional view taken along a line III-III′ shown in FIG. 3.

Referring to FIGS. 4 to 6, the display panel 110 includes a first base substrate 111, a second base substrate 116 facing the first base substrate 111, and an electrophoretic material 50 interposed between the first and second base substrates 111 and 116. The electrophoretic material includes the dielectric solvent 51 and the electrophoretic particles 52 dispersed in the dielectric solvent 51. Each of the electrophoretic particles 52 is charged to the positive (+) polarity and has the black color.

The first base substrate 111 and the second base substrate 116 may be formed of the same material. The first base substrate 111 may be formed of a transparent member, such as a glass substrate, a plastic substrate, a silicon substrate, etc.

The gate electrode GE of the thin film transistor TR and the storage electrode STE are formed on the first base substrate 111. In addition, a gate insulating layer 112 is formed on the first base substrate 111 to cover the gate electrode GE and the storage electrode STE.

A semiconductor layer SEL is formed on the gate insulating layer 112 that covers the gate electrode GE. Although not shown in FIG. 4, the semiconductor layer SEL may include an active layer and an ohmic contact layer. The source electrode SE and the drain electrode DE of the thin film transistor TR are formed on the semiconductor layer SEL and the gate insulating layer 112 and spaced apart from each other.

The source electrode SE and the drain electrode DE are covered by a protective layer 113. Although not shown in FIGS. 4 to 6, the data lines DL1 to DLm are formed on the gate insulating layer 112 and covered by the protective layer 113. The pixel electrode PE and the connection electrode CNE branched from the pixel electrode PE are formed on the protective layer 113. The pixel electrode PE is overlapped with the storage electrode STE, and the pixel electrode PE and the storage electrode STE form the boost capacitor.

The drain electrode DE is electrically connected to the connection electrode CNE branched from the first branch portions 10 of the pixel electrode PE through the contact hole H formed through the protective layer 113.

FIG. 4 shows the first area P1 of the pixel electrode PE, the first branch portions 10 of the second area P2, and the slit areas 30 of the second area 20.

FIG. 5 shows the first area P1 of the pixel electrode PE and the slit areas 30 of the second area P2.

FIG. 6 shows the first area P1 of the pixel electrode PE and the second branch portions 20 of the second area P2.

A first insulating layer 114 is formed on the protective layer 113 to cover the pixel electrode PE. The barrier wall electrode 115 is formed on the first insulating layer 114 to partition the pixels PX. The electrophoretic material 50 is accommodated in the pixel areas defined by the barrier wall electrode 115.

Although not shown in FIGS. 4 to 6, color filters, each of which has a red color, a green color, or a blue color, may be formed on the second base substrate 110.

The protective layer 114 may include a material that serves as a reflective plate, or a separate reflective plate may be disposed on the protective layer 114. Regardless of the material used for the pixel electrode PE, a separate reflective plate may be disposed on the pixel electrode PE. Hereinafter, the pixel electrode PE formed of the reflective metal material will be described as an example.

The electrophoresis display apparatus 100 controls the movement of the electrophoretic particles 52 in accordance with the voltage applied to the barrier wall electrode 115, the polarity of the voltage applied to the pixel electrode PE, and the intensity of the voltage applied to the pixel electrode PE to display the gray scales. This will be described in detail with reference to FIGS. 7A, 7B, 8A, and 8B below.

FIG. 7A is a waveform diagram showing a storage voltage applied to a pixel in order to display a white gray scale and a state of a voltage level state of a pixel electrode, and FIG. 7B is a waveform diagram showing a storage voltage applied to a pixel in order to display a black gray scale and a state of a voltage level state of a pixel electrode.

In addition, FIG. 8A is a cross-sectional view showing a movement of electrophoretic particles of a pixel in accordance with the storage voltage and the voltage level of the pixel electrode shown in FIG. 7A, and FIG. 8B is a cross-sectional view showing a movement of electrophoretic particles of a pixel in accordance with the storage voltage and the voltage level of the pixel electrode shown in FIG. 7B.

For the convenience of explanation, in FIGS. 7A and 7B, a first gate signal Gi, a second gate signal Gi+1, a first storage signal Si, and a second storage signal Si+1, which are applied to the corresponding pixel of the pixels PX through a first gate line GLi, a second gate line GLi+1, a first storage line SLi, and a second storage line SLi+1, have been shown. In addition, a level of a pixel electrode voltage VPEi of each of the pixels connected to the first gate line GLi and arranged in a first row and a level of a pixel electrode voltage VPEi+1 of each of the pixels connected to the second gate line GLi+1 and arranged in a second row have been shown in FIGS. 7A and 7B.

Referring to FIGS. 7A and 8A, each pixel PX is applied with the first data voltage +VD1 so as to display the white gray scale in response to the gate signals sequentially applied to the rows. Each pixel PX is operated in the same way in order to display the white gray scale, and thus, hereinafter the level of the pixel electrode voltage VPEi of each pixel arranged in the first row will be described as an example.

The barrier wall electrode 115 is applied with a barrier wall voltage Vwe having an intermediate level between the first data voltage +VD1 and the second data voltage −VD1.

Each pixel PX arranged in the first row is applied with the first data voltage +VD1 in response to the first gate signal Gi. Thus, the first data voltage +VD1 is applied to the pixel electrode PE of each pixel PX arranged in the first row.

In detail, the first data voltage +VD1 applied to the pixel electrode PE has a level higher than the barrier wall voltage Vwe applied to the barrier wall electrode 115. In this case, the first data voltage +VD 1 may be defined as a positive (+) first data voltage and the barrier wall voltage Vwe may be defined as a negative (−) barrier wall voltage. Accordingly, the pixel electrode PE is represented as being positive (+) and the barrier wall electrode 115 is represented as being negative (−) as shown in FIG. 8A.

The first data voltage +VD1 is applied to the pixel electrode PE of each pixel PX arranged in the first row. Therefore, the level of the pixel electrode voltage VPEi is increased to the level of the first data voltage +VD 1 during a high level period G_H of the first gate signal Gi.

The low level of the first storage signal Si indicates the first storage voltage Vcst1 and the high level of the first storage signal Si indicates the second storage voltage Vcst2.

The first storage signal Si is changed to the low level from the high level before the first gate signal Gi is applied to each pixel PX of the first row. Accordingly, the storage electrode STE is applied with the first storage voltage Vcst1 as the first storage signal Si. A low level period S_L of the first storage signal Si may be set to be longer than the high level period G_H of the first gate signal Gi.

Thus, the first storage signal Si is maintained in the low level while the first data voltage +VD1 is applied to each pixel PX of the first row. That is, the first storage signal Si is maintained in the level of the first storage voltage Vcst1 and the storage electrode STE is applied with the first storage voltage Vcst1.

After the first data voltage +VD 1 is applied to each pixel PX of the first row, the first storage signal Si is changed to the high level. Accordingly, the storage electrode STE is applied with the second storage voltage Vcst2 as the first storage signal Si. In other words, the level of the voltage applied to the storage electrode STE is increased to the level of the second storage voltage Vcst2 from the level of the first storage voltage Vcst1.

The pixel electrode voltage VPEi is boosted up due to the boost capacitor CBoost by the level difference ΔV between the first storage voltage Vcst1 and the second storage voltage Vcst2. That is, the pixel electrode voltage VPEi has a voltage level +VD2 higher than the first data voltage +VD1 by the level difference ΔV between the first storage voltage Vcst1 and the second storage voltage Vcst2.

The pixel electrode voltage VPEi may be decreased to a predetermined level by a discharge of the boost capacitor CBoost in a present frame (1Frame). The pixel electrode voltage VPEi is lowered by the level difference ΔV between the first storage voltage Vcst1 and the second storage voltage Vcst2 when the first storage signal Si is changed to the low level from the high level in a next frame. Then, the above-mentioned operation of the pixel electrode voltage VPEi is repeatedly performed every frame.

As an example, the first data voltage +VD1, the first storage voltage Vcst1, and the second storage voltage Vcst2 may be set to about +10 volts, about −5 volts, and about +5 volts, respectively.

The first data voltage +VD 1 of about +10 volts is charged to each pixel PX of the first row, and the level of the pixel electrode voltage VPEi becomes the level of the first data voltage +VD1 of about +10 volts during the high level period G_H of the first gate signal Gi.

The first storage signal Si is changed to the level of the first storage voltage Vcst1 of about −5 volts from the level of the second storage voltage Vcst2 of about +5 volts before the first gate signal Gi is applied to each pixel PX of the first row. Thus, the first storage voltage Vcst1 of about −5 volts is applied to the storage electrode STE.

The first storage signal Si is maintained in the level of the first storage voltage Vcst1 of about −5 volts while the first data voltage +VD1 of about +10 volts is charged to each pixel PX of the first row.

After the first data voltage +VD 1 is charged to each pixel PX of the first row, the first storage signal Si is changed to the second storage voltage Vcst2 of about +5 volts from the first storage voltage Vcst1 of about −5 volts. Accordingly, the second storage voltage Vcst2 of about +5 volts is applied to the storage electrode STE.

The level of the voltage applied to the storage electrode STE is increased by about 10 volts, from about −5 volts to about +5 volts, after the first data voltage +VD 1 is applied to each pixel PX. Therefore, the pixel electrode voltage VPEi is boosted up by about 10 volts by the boost capacitor CBoost until the pixel electrode voltage VPEi reaches about +20 volts. In this case, the pixel electrode PE is charged to have the positive (+) polarity and the barrier wall electrode 115 is charged to have the negative (−) polarity as shown in FIG. 8A.

The level of the pixel electrode voltage VPEi is boosted up to a certain level higher than the level of the first data voltage +VD1. Accordingly, an electric field formed between the pixel electrode PE and the barrier wall electrode 115 becomes much stronger than the electric field formed between the pixel electrode PE and the barrier wall electrode 115 when the pixel electrode voltage VPEi has the level of the first data voltage +VD1. As a result, an attractive force between the barrier wall electrode 115 and the electrophoretic particles 52 charged to the positive (+) polarity becomes stronger, so that the electrophoretic particles 52 move easily to the barrier wall electrode 115.

As shown in FIG. 8A, since the electrophoretic particles 52 move to the barrier wall electrode 115, the light incident to each pixel PX is reflected by the pixel electrode PE and passes through the second base substrate 116. As a result, each pixel PX may display the white gray scale.

The first data voltage applied to each pixel PX in order to display the white gray scale may be defined as a white data voltage or a reset voltage. In addition, the operation of the electrophoresis display apparatus 100 for the white gray scale may be defined as a reset operation.

Each pixel PX requires a plurality of frames in order to display the white gray scale. The plurality of frames requires to display the white gray scale may be defined as one frame set, and the one frame set depends on a response speed of the electrophoresis display apparatus 100.

For instance, the electrophoresis display apparatus 100 may have the response speed of about 100 ms to about 200 ms. In more detail, when the electrophoresis display apparatus 100 has the response speed of about 200 ms and one frame is set to have about 5 ms, 40 frames are required to display the white gray scale. That is, the above-mentioned operation has to be repeated 40 times to get a white gray scale in each pixel.

Referring to FIGS. 7B and 8B, each pixel PX is applied with the second data voltage −VD1 so as to display the black gray scale in response to the gate signals sequentially applied to the rows. Each pixel PX is operated in the same way in order to display the black gray scale, so that hereinafter the level of the pixel electrode voltage VPEi of each pixel arranged in the first row will be described as an example.

Each pixel PX arranged in the first row is applied with the second data voltage −VD1 in response to the first gate signal Gi. Thus, the second data voltage −VD 1 is applied to the pixel electrode PE of each pixel PX arranged in the first row. In detail, the second data voltage −VD1 applied to the pixel electrode PE has a level lower than the barrier wall voltage Vwe applied to the barrier wall electrode 115. In this case, the second data voltage −VD 1 is defined as the negative (−) data voltage and the barrier wall voltage Vwe is defined as the positive (+) barrier wall voltage. Accordingly, the pixel electrode PE is represented as being the negative (−) and the barrier wall electrode 115 is represented as being positive (+) as shown in FIG. 8B.

The second data voltage −VD1 is applied to the pixel electrode PE of each pixel PX arranged in the first row. Therefore, the level of the pixel electrode voltage VPEi is decreased to the level of the second data voltage −VD 1 during the high level period G_H of the first gate signal Gi.

The first storage signal Si is changed to the high level from the low level before the first gate signal Gi is applied to each pixel PX of the first row. Accordingly, the storage electrode STE is applied with the second storage voltage Vcst2 as the first storage signal Si. A high level period S_H of the first storage signal Si may be set to be longer than the high level period G_H of the first gate signal Gi.

Thus, the first storage signal Si is maintained in the high level while the second data voltage −VD1 is applied to each pixel PX of the first row. That is, the first storage signal Si is maintained in the level of the second storage voltage Vcst2 and the storage electrode STE is applied with the second storage voltage Vcst2.

After the second data voltage −VD1 is applied to each pixel PX of the first row, the first storage signal Si is changed to the low level. Accordingly, the storage electrode STE is applied with the first storage voltage Vcst1 as the first storage signal Si. In other words, the level of the voltage applied to the storage electrode STE is decreased to the level of the first storage voltage Vcst1 from the level of the second storage voltage Vcst2.

The pixel electrode voltage VPEi is boosted down due to the boost capacitor CBoost by the level difference ΔV between the first storage voltage Vcst1 and the second storage voltage Vcst2. That is, the pixel electrode voltage VPEi has a voltage level −VD2 lower than the second data voltage −VD1 by the level difference ΔV between the first storage voltage Vcst1 and the second storage voltage Vcst2.

The pixel electrode voltage VPEi may be increased to a predetermined level by the discharge of the boost capacitor CBoost in the present frame (1Frame). The pixel electrode voltage VPEi becomes high by the level difference ΔV between the first storage voltage Vcst1 and the second storage voltage Vcst2 when the first storage signal Si is changed to the high level from the low level in the next frame. Then, the above-mentioned operation of the pixel electrode voltage VPEi is repeatedly performed every frame.

As an example, the second data voltage −VD1, the first storage voltage Vcst1, and the second storage voltage Vcst2 may be set to about −10 volts, about −5 volts, and about +5 volts, respectively.

The second data voltage −VD1 of about −10 volts is charged to each pixel PX of the first row, and the level of the pixel electrode voltage VPEi becomes the level of the second data voltage −VD1 of about −10 volts during the high level period G_H of the first gate signal Gi.

The first storage signal Si is changed to the level of the second storage voltage Vcst1 of about +5 volts from the level of the first storage voltage Vcst2 of about −5 volts before the first gate signal Gi is applied to each pixel PX of the first row. Thus, the second storage voltage Vcst1 of about +5 volts is applied to the storage electrode STE.

The first storage signal Si is maintained in the level of the second storage voltage Vcst2 of about +5 volts while the second data voltage −VD1 of about −10 volts is charged to each pixel PX of the first row.

After the second data voltage −VD 1 is charged to each pixel PX of the first row, the first storage signal Si is changed to the first storage voltage Vcst1 of about −5 volts from the second storage voltage Vcst2 of about +5 volts. Accordingly, the first storage voltage Vcst1 of about −5 volts is applied to the storage electrode STE.

The level of the voltage applied to the storage electrode STE is decreased by about 10 volts, from about +5 volts to about −5 volts, after the second data voltage −VD1 is applied to each pixel PX. Therefore, the pixel electrode voltage VPEi is boosted down by about 10 volts by the boost capacitor CBoost until the pixel electrode voltage VPEi reaches about −20 volts. In this case, the pixel electrode PE is charged to have the negative (−) polarity and the barrier wall electrode 115 is charged to have the positive (+) polarity as shown in FIG. 8B.

The level of the pixel electrode voltage VPEi is boosted down to a certain level lower than the level of the second data voltage −VD1. Accordingly, an electric field formed between the pixel electrode PE and the barrier wall electrode 115 becomes much stronger than the electric field formed between the pixel electrode PE and the barrier wall electrode 115 when the pixel electrode voltage VPEi has the level of the second data voltage −VD1. As a result, the attractive force between the pixel electrode PE and the electrophoretic particles 52 charged to the positive (+) polarity becomes stronger, so that the electrophoretic particles 52 move easily to the pixel electrode PE.

In the case that the pixel electrode PE is not formed in the feather pattern, the electric field between the barrier wall electrode and a center area of the pixel electrode may be substantially weaker than the electric field between the barrier wall electrode and a peripheral area of the pixel electrode.

The center area of the pixel electrode corresponds to the first area P1 of the pixel electrode PE of the present exemplary embodiment and the peripheral area of the pixel electrode corresponds to the second area P2 of the pixel electrode PE of the present exemplary embodiment. In this case, the electrophoretic particles may not be gathered in the center area of the pixel electrode. When the electrophoretic particles are not gathered in the center area, the black gray scale may not be displayed normally. As a result, the contrast ratio of the image is deteriorated.

The pixel electrode PE according to the present exemplary embodiment may be formed in the feather pattern. Since the pixel electrode PE is not formed in the slit areas 30 of the second area P2 of the pixel electrode PE, the electric field does not exist in the slit areas 30. The electric field is formed between the barrier wall electrode 115 and the first and second branch portions 10 and 20.

The intensity of the electric field formed between the first area P1 of the pixel electrode PE and the barrier wall electrode 115 may be weaker than the intensity of the electric field formed between the peripheral area of the pixel electrode P2 and the barrier wall electrode 115 when the pixel electrode PE is not formed in the feather pattern. Accordingly, the intensity of the electric field in the first area P1 may be the same as the intensity of the electric field in the second area P2 when the pixel electrode PE is formed in the feather pattern. As a result, the electrophoretic particles 52 may be uniformly distributed on the pixel electrode PE as shown in FIG. 8B.

When the electrophoretic particles 52 are uniformly distributed on the pixel electrode PE of the pixel, the light incident to each pixel PX is absorbed by the electrophoretic particles 52. Thus, each pixel PX may display the black gray scale normally.

The second data voltage −VD1 applied to each pixel PX in order to display the black gray scale may be defined as a black data voltage.

As described above, when the electrophoresis display apparatus 100 has the response speed of about 200 ms and one frame is set to have about 5 ms, 40 frames are required to display the black gray scale. That is the above-mentioned operation has to be repeated 40 times to get a black gray scale in each pixel.

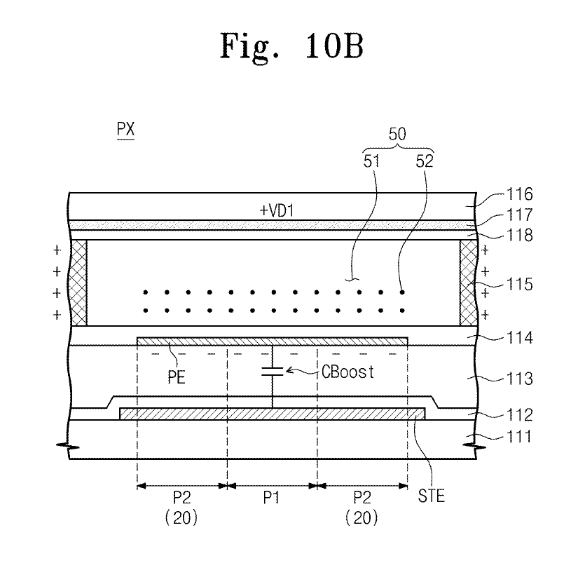

After each pixel PX is reset to the white gray scale, each pixel PX is maintained in the white gray scale or displays an intermediate gray scale between the black color and the white color. The pixels used to display the black gray scale receive the second data voltage −VD1 during the 40 frames. The pixels used to display the white gray scale receive the first data voltage +VD1 without being applied with the second data voltage −VD1. The operation of the pixels to maintain the white gray scale will be described in detail with reference to FIG. 9 later.

The pixel used to display a intermediate gray scale between the black color and the white color receives the second data voltage −VD1 from 1 to 39 times. As the number of times that the second data voltage −VD 1 is applied to the pixel increases, the pixel displays the gray scale closer to the black gray scale. As a result, each pixel PX may display gray scales within a range from 0 to 40 steps.

In the present exemplary embodiment, the operation of each pixel PX has been described in the case that the first storage voltage Vcst1 has the level lower than the level of the second storage voltage Vcst2, but it should not be limited thereto or thereby. That is, the second storage voltage Vcst2 may have the level lower than the level of the first storage voltage Vcst1. In this case, voltages opposite to the voltages applied to each pixel PX described above are applied to each pixel PX in order to display the white and black gray scales.

With reference to the configuration and the operation of the above-described electrophoresis display apparatus 100, the electrophoresis display apparatus 100 is operated using the low data voltage in the same way as when the electrophoresis display apparatus 100 is operated using the high data voltage. Accordingly, the electrophoresis display apparatus 100 according to the present exemplary embodiment may be operated by using the data driver at the low price, and the manufacturing cost of the electrophoresis display apparatus 100 may be reduced.

In addition, the electrophoretic particles 52 may be uniformly distributed on the pixel electrode PE of each pixel PX. As a result, the electrophoresis display apparatus 100 may display the black gray scale normally, thereby improving the contrast ratio of the image displayed thereon.

FIG. 9 is a cross-sectional view showing electrophoretic particles in adjacent pixels to each other among pixels shown in FIG. 1, which respectively display a black gray scale and a white gray scale.

Referring to FIG. 9, among the pixels, a first pixel PX1 displays the black gray scale and a second pixel PX2 disposed adjacent to the first pixel PX1 is maintained in the reset state so as to display the white gray scale. As described above, each pixel PX of the electrophoresis display apparatus 100 receives the second data voltage −VD1 to display the black gray scale after being reset to the white gray scale.

However, the pixel PX maintained in the white gray scale may exist in the pixels PX. In this case, the pixel maintained in the white gray scale may receive the first data voltage +VD1. The storage signal is applied to the storage electrode STE as shown in FIG. 7B.

The first pixel PX1 receives the second data voltage to display the black gray scale. Since the operation of the first pixel PX1 displaying the black gray scale has been described, details thereof will be omitted.

The second pixel PX2 for the white gray scale receives the first data voltage +VD1 during the high level period of the corresponding gate signal and the storage signal applied to the storage electrode STE of the second pixel PX2 is maintained in the high level. After the first data voltage +VD1 is applied to the second pixel PX2, the storage signal is changed to the low level from the high level and applied to the storage electrode STE of the second pixel PX2.

The voltage of the pixel electrode PE of the second pixel PX2 is boosted down from the first data voltage +VD1 due to the boost capacitor CBoost by the level difference between the first and second storage voltages Vcst1 and Vcst2. That is, the voltage level of the pixel electrode PE of the second pixel PX2 may be lower than the level of the first voltage level +VD1, which is equal to the level of the barrier wall voltage Vwe.

As an example, the voltage level of the barrier wall voltage Vwe, the voltage level of first data voltage +VD1, the voltage level of the first storage voltage Vcst1, and the voltage level of the second storage voltage Vcst2 may be set to about 0 volts, about +10 volts, and about −5 volts, and about +5 volts, respectively.

After the first data voltage +VD1 of about +10 volts is applied to the second pixel PX2, the storage signal is changed to the first storage voltage Vcst1 of about −5 volts from the second storage voltage Vcst2 of about +5 volts. Accordingly, the first storage voltage Vcst1 is applied to the storage electrode STE. As a result, the voltage level of the pixel electrode PE of the second pixel PX2 is boosted down from the level of the first data voltage +VD1 of about +10 volts by about 10 volts, which corresponds to the level difference between the first and second storage voltages Vcst1 and Vcst2, by the boost capacitor CBoost. That is, the voltage level of the pixel electrode PE of the second pixel PX2 becomes 0 volts equal to the voltage level of the barrier wall voltage Vwe as shown in FIG. 9.

Since the voltage level of the barrier wall voltage Vwe is equal to the voltage level of the pixel electrode PE of the second pixel PX2, no electric field is formed between the barrier wall electrode 115 and the pixel electrode PE of the second pixel PX2. As a result, as shown in FIG. 9, the second pixel PX2 is maintained in the reset state and the electrophoretic particles 52 are maintained in the state in which the electrophoretic particles 52 move to the barrier wall electrode 115. Thus, the second pixel PX2 repeatedly performs the above-mentioned operation during the one frame set, thereby maintaining the white gray scale.

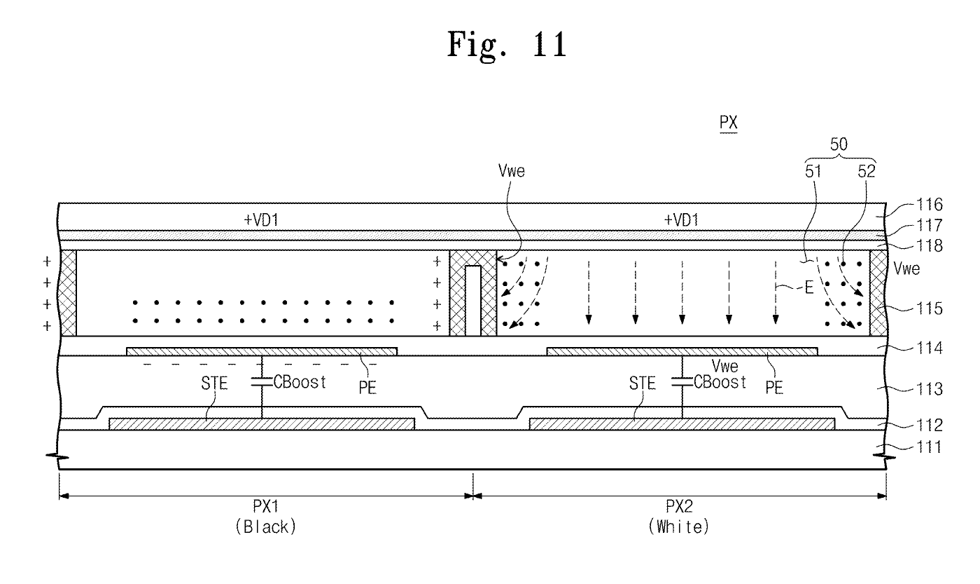

FIGS. 10A and 10B are cross-sectional views showing a pixel of an electrophoresis display apparatus according to a second exemplary embodiment of the present invention.

FIG. 10A shows the movement of the electrophoretic particles of the pixel that displays the white gray scale and FIG. 10B shows the movement of the electrophoretic particles of the pixel that displays the black gray scale.

The pixel PX of the electrophoresis display apparatus according to the second exemplary embodiment has the same configuration and function as those of the pixel PX of the electrophoresis display apparatus 100 according to the first exemplary embodiment except a resist electrode 117 and a second insulating layer 118. Substantially, the cross-sectional views shown in FIGS. 10A and 10B are the same as cross-sectional views taken along the line I2-I2′ shown in FIG. 3 except the resist electrode 117 and the second insulating layer 118. Accordingly, in FIGS. 10A and 10B, the same reference numerals denote the same elements in FIG. 6, and thus detailed descriptions of the same elements will be omitted. Hereinafter, configuration and operation of the electrophoresis display apparatus according to the second exemplary embodiment, which are different from those of the electrophoresis display apparatus 100 according to the first exemplary embodiment, will be described in detail.

Referring to FIGS. 10A and 10B, the resist electrode of the pixel PX of the electrophoresis display apparatus according to the second exemplary embodiment is formed on a second base substrate 116, and the second insulating layer 118 is formed on the resist electrode 117. The resist electrode 117 may include a transparent conductive material.

The positive (+) first data voltage +VD1 or the negative (−) second data voltage −VD1 is applied to the resist electrode 117. The voltage applied to the resist electrode 117 may be maintained uniformly. As an example, the resist electrode 117 is applied with the first data voltage +VD 1.

Referring to FIG. 10A again, when the white gray scale is displayed, the voltage level of the pixel electrode PE is boosted up by the level difference between the first storage voltage Vcst1 and the second storage voltage Vcst2 from the first data voltage +VD1 by the boost capacitor CBoost. This operation has been already described, and thus details thereof will be omitted.

An electric field (hereinafter, referred to as a first electric field) is formed between the pixel electrode PE and the barrier wall electrode 115. The resist electrode 117 is maintained in the first data voltage +VD1 lower than the voltage level of the pixel electrode PE. Since the first data voltage +VD1 is higher than the voltage applied to the barrier wall electrode 115, an electric field (hereinafter, referred to as a second electric field), which is weaker than the first electric field, is formed between the resist electrode 117 and the barrier wall electrode 115.

For instance, when the first data voltage +VD1, the first storage voltage Vcst1, and the second storage voltage Vcst2 are respectively set to about +10 volts, about −5 volts, and +5 volts, the voltage level of the pixel electrode PE may be boosted up to about +20 volts by the boost capacitor CBoost. Since the voltage level of the resist electrode 117 is about +10 volts and the voltage level of the pixel electrode PE is about +20 volts, the intensity of the first electric field is stronger than the intensity of the second electric field.

Due to the first and second electric fields, the attractive force between the barrier wall electrode 115 and the electrophoretic particles 52 charged to the positive (+) polarity becomes stronger, so that the electrophoretic particles 52 move easily to the barrier wall electrode 115.

According to the first exemplary embodiment, only the first electric field exists between the barrier wall electrode 115 and the pixel electrode PE of the pixel PX of the electrophoresis display apparatus 100, but the first and second electric fields exist in the pixel PX shown in FIG. 10A. The electrophoretic particles 52 in the first and the second electric fields are more influenced by both of the electric fields than the electrophoretic particles 52 in the first field only. Thus, the electrophoretic particles 52 may more easily move to the barrier wall electrode 115 in the pixel PX shown in FIG. 10A than the electrophoretic particles 52 of the pixel PX of the electrophoresis display apparatus 100 according to the first exemplary embodiment. The electrophoretic particles 52 move to the barrier wall electrode 115 and the pixel PX displays the white gray scale. The operation that displays the white gray scale during the one frame set has been already described, and thus details thereof will be omitted.

Consequently, the electrophoretic particles 52 may relatively easily move to the barrier wall electrode 115 by the resist electrode 117 when compared with the electrophoretic particles 52 in the pixel PX of the electrophoresis display apparatus 100, to which no resist electrode is applied, according to the first exemplary embodiment.

Referring to FIG. 10B, when the black gray scale is displayed, the voltage level of the pixel electrode PE is boosted down by the level difference between the first storage voltage Vcst1 and the second storage voltage Vcst2 from the second data voltage −VD1 by the boost capacitor CBoost. This operation has been already described, and thus details thereof will be omitted.

An electric field (hereinafter, referred to as a third electric field) is formed between the pixel electrode PE and the barrier wall electrode 115. As described above, the resist electrode 117 is maintained in the first data voltage +VD1 and the second electric field is formed between the resist electrode 117 and the barrier wall electrode 115.

For instance, when the second data voltage −VD1 is about −10 volts, the voltage level of the pixel electrode PE may be boosted down to about −20 volts by the boost capacitor CBoost. The level difference between the pixel electrode PE and the barrier wall electrode 115 is larger than the level difference between the resist electrode 117 and the barrier wall electrode 115. That is, the intensity of the third electric field is stronger than the intensity of the second electric field. Therefore, the attractive force acting between the pixel electrode PE and the electrophoretic particles 52 by the third electric field is greater than the attractive force acting between the barrier wall electrode 115 and the electrophoretic particles 52 by the second electric field.

Consequently, the electrophoretic particles 52 charged to the positive (+) polarity move onto the pixel electrode PE. Each of the first, second, and third electric fields is a horizontal electric field component.

The resist electrode 117 has the voltage level of about +10 volts and the pixel electrode PE has the voltage level of about −20 volts. Accordingly, a vertical electric field (hereinafter, referred to as a fourth electric field) may be formed between the resist electrode 117 and the pixel electrode PE. The attractive force between the pixel electrode PE and the electrophoretic particles 52, which are charged to the positive (+) polarity, by the fourth electric field becomes much stronger. However, since the electrophoretic particles 52 have already moved onto the pixel electrode PE, the electrophoretic particles 52 may be remained on the pixel electrode PE without being influenced by the fourth electric field.

The electrophoretic particles 52 move onto the pixel electrode PE and the pixel PX displays the black gray scale. The operation that displays the black gray scale during the one frame set has been already described, and thus details thereof will be omitted.

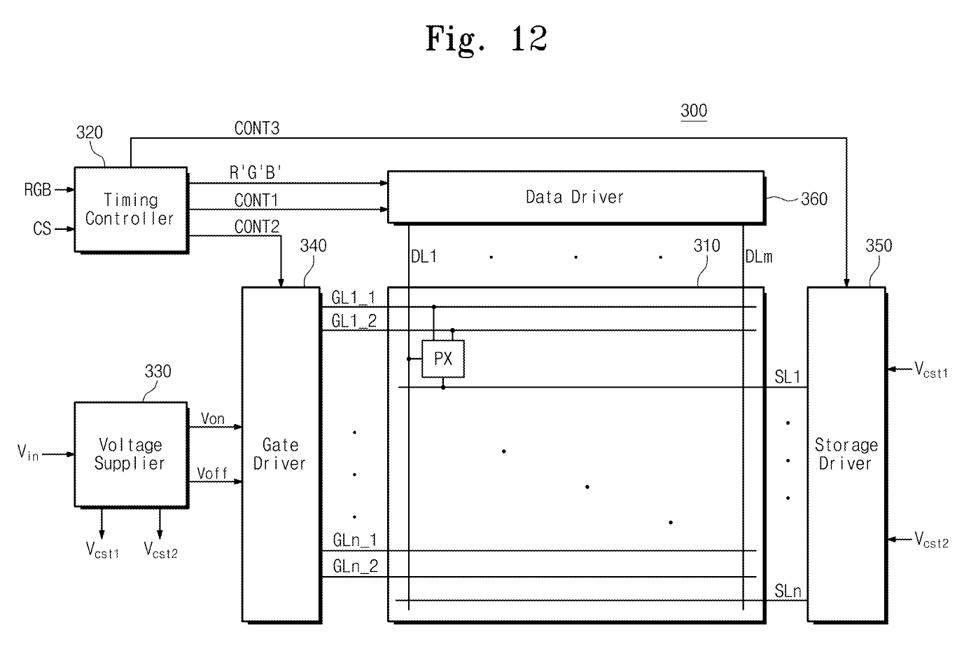

FIG. 11 is a cross-sectional view showing electrophoretic particles in adjacent pixels to each other among pixels according to the second exemplary embodiment of the present invention, which respectively display a black gray scale and a white gray scale.

Referring to FIG. 11, among the pixels, a first pixel PX1 displays the black gray scale and a second pixel PX2 disposed adjacent to the first pixel PX1 is maintained in the reset state so as to display the white gray scale. The operation of the first pixel PX1 that displays the black gray scale have been already described, and thus details thereof will be omitted.

With reference to the operation of the pixel described in FIG. 9, the first pixel PX1 receives the second data voltage −VD1 to display the black gray scale and the second pixel PX2 receives the first data voltage +VD1 to maintain the white gray scale.

The second pixel PX2 receives the first data voltage +VD1 in order to maintain the white gray scale. The voltage of the pixel electrode PE of the second pixel PX2 is boosted down from the first data voltage +VD1 due to the boost capacitor CBoost by the level difference between the first and second storage voltages Vcst1 and Vcst2. That is, the voltage level of the pixel electrode PE of the second pixel PX2 may be lower than the level of the first voltage level +VD1, which is equal to the level of the barrier wall voltage Vwe.

Accordingly, as shown in FIG. 11, a horizontal electric field is formed between the resist electrode 117 and the barrier wall electrode 115 and a vertical electric field is formed between the resist electrode 115 and the pixel electrode PE. Since the voltage level of the barrier wall electrode 115 is equal to the voltage level of the pixel electrode PE of the second pixel PX2, no electric field is formed between the barrier wall electrode 115 and the pixel electrode PE of the second pixel PX2.

As a result, the attractive force is formed between electrophoretic particles 52 and the barrier wall electrode 115 by the horizontal electric field formed between barrier wall electrode 115 and the resist electrode 117. Thus, the electrophoretic particles 52 may be remained on the barrier wall electrode 115 without being influenced by the fourth electric field. Consequently, the second pixel PX2 may be maintained in the reset state, thereby displaying the white gray scale.

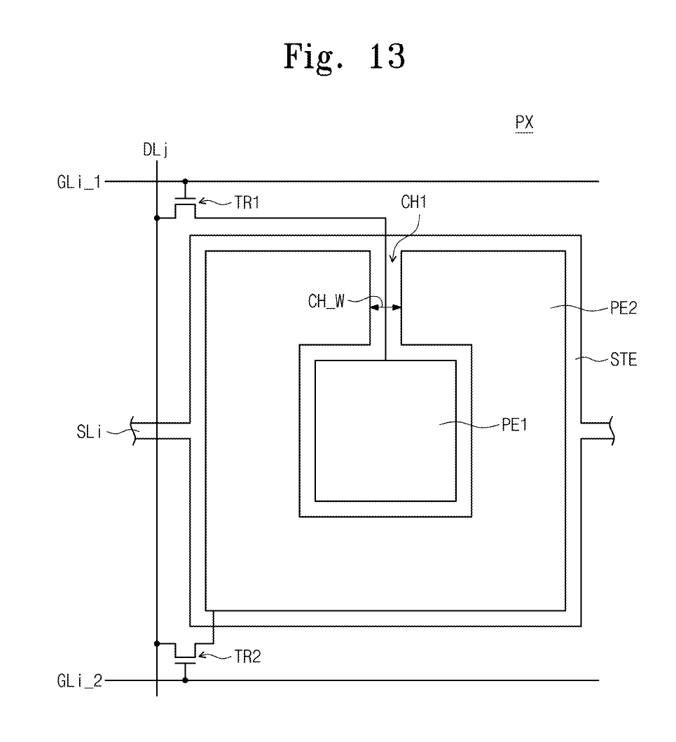

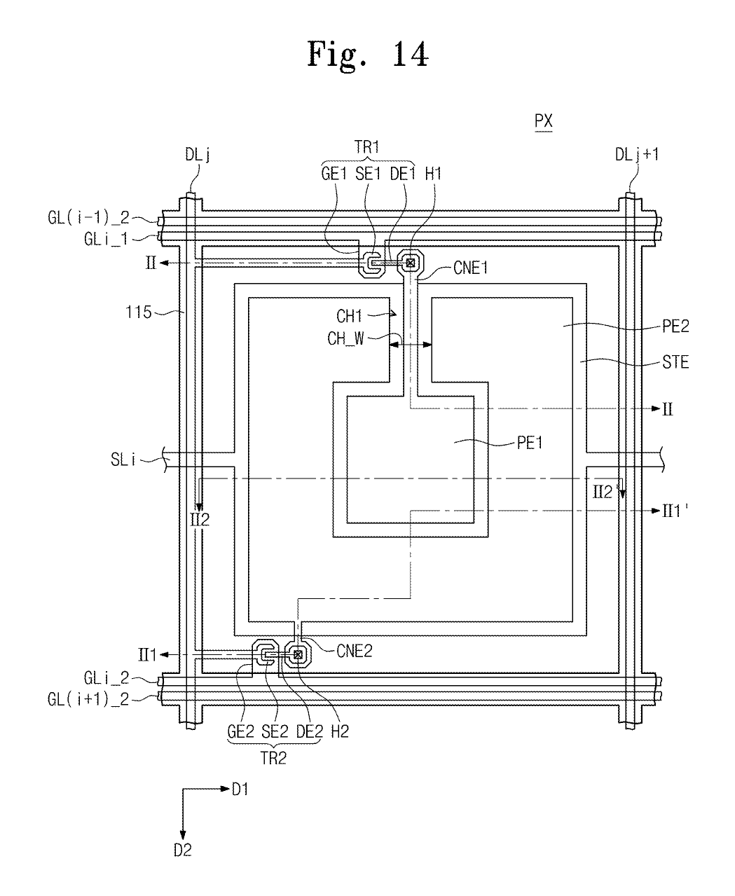

FIG. 12 is a block diagram showing an electrophoresis display apparatus according to a third exemplary embodiment of the present invention and FIG. 13 is a plan view showing a pixel shown in FIG. 12. The pixels shown in FIG. 12 have the same configuration and function, and thus, for the convenience of explanation, one pixel has been shown in FIG. 13.

The electrophoresis display apparatus 300 shown in FIG. 12 have the same configuration as the electrophoresis display apparatus 100 shown in FIG. 1 except that each pixel is connected to first and second gate lines. Accordingly, the different parts from those in the first exemplary embodiment will be mainly described.

Referring to FIGS. 12 and 13, a plurality of gate lines GL1_1 to GLn_2 is connected to each pixel PX arranged in the corresponding row through a pair of first and second gate lines GLi_1 and GLi_2. A gate driver 340 sequentially applies gate signals to the pixels PX through the gate lines GL1_1 to GLn_1 including the first and second gate lines GLi_1 and GLi_2.

Each pixel PX is turned on in response to first and second gate signals respectively provided through corresponding first and second gate lines GLi_1 and GLi_2 to receive a data voltage through a corresponding data line.

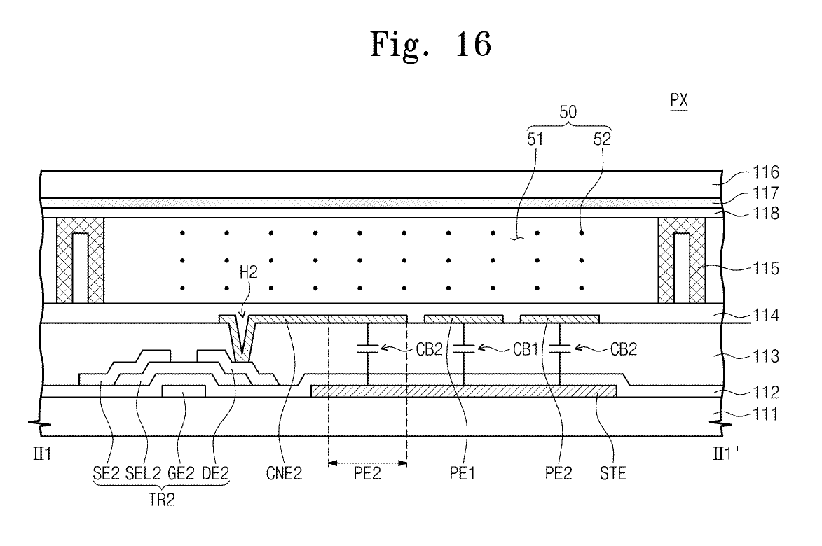

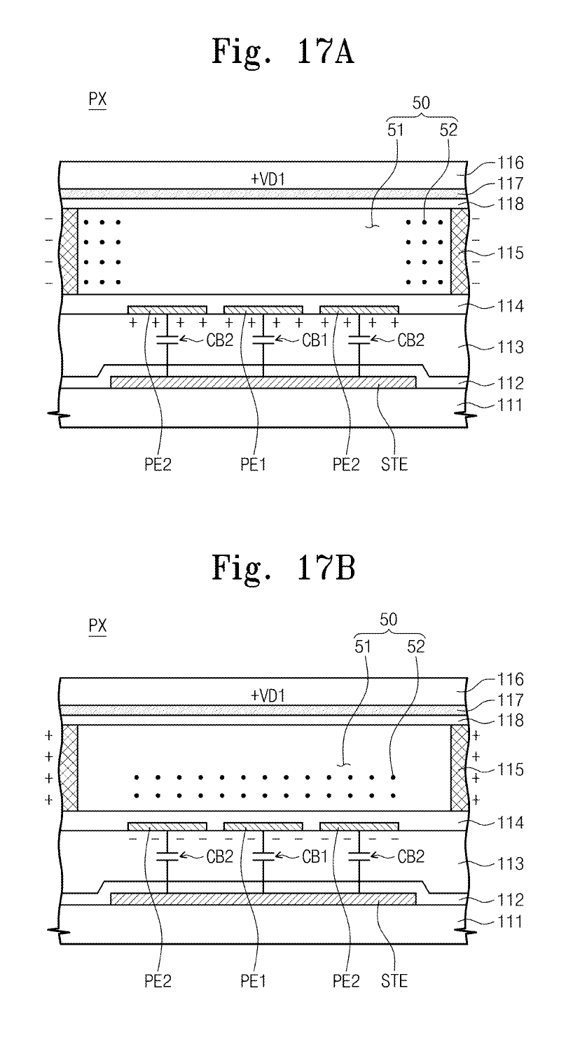

Each pixel PX includes a first thin film transistor TR1, a second thin film transistor TR2, a first pixel electrode PE1, a second pixel electrode PE2, a first channel area CH1, a storage electrode STE, a first boost capacitor formed by the first pixel electrode PE1 and the storage electrode STE, and a second boost capacitor formed by the second pixel electrode PE2 and the storage electrode STE. The first and second boost capacitors will be described in detail with reference to FIGS. 15 and 16.

The first thin film transistor TR1 includes a first gate electrode connected to a corresponding first gate line GLi_1, a first source electrode connected to a corresponding data line DLj, and a first drain electrode connected to the first pixel electrode PE1.

The second thin film transistor TR2 includes a second gate electrode connected to a corresponding second gate line GLi_2, a second source electrode connected to a corresponding data line DLj, and a second drain electrode connected to the second pixel electrode PE2.

The storage electrode STE is branched from the storage line SLi.

The first channel area CH1 serves as a path through which the first drain electrode of the first thin film transistor TR1 is connected to the first pixel electrode PE1. The second pixel electrode PE2 is not formed in the first channel area CH1.

The first pixel electrode PE1 is formed in the center area of the pixel PX. The second pixel electrode PE2 is formed to surround the first pixel electrode PE2 and spaced apart from the first pixel electrode PE2. The second pixel electrode PE2 is formed in the area except the first channel area CH1.

The first pixel electrode PE1 of the pixel PX is connected to the data line DLj through the first thin film transistor TR1 which turns on in response to the first gate signal provided through the first gate line GLi_1. Thus, the first pixel electrode PE1 of the pixel PX is applied with the first data voltage through the data line DLj.

The second pixel electrode PE2 of the pixel PX is connected to the data line DLj through the second thin film transistor TR2 which turns on in response to the second gate signal provided through the second gate line GLi_2. Thus, the second pixel electrode PE2 of the pixel PX is applied with the first data voltage through the data line DLj.

The data voltage applied to each pixel PX includes a first data voltage used to display the white gray scale and a second data voltage used to display the black gray scale.

When each pixel PX displays the white gray scale, each pixel PX receives the first data voltage in response to the first and second gate signals sequentially provided through the first and second gate lines GLi_1 and GLi_2. Therefore, the first data voltage is applied to the first and second pixel electrodes PE1 and PE2.

The storage signal is maintained in the level of the first storage voltage Vcst1 while each pixel PX receives the first data voltage in response to the first and second gate signals.

After the first data voltage is applied to the second pixel electrode PE2, the storage signal is changed to the level of the second storage voltage Vcst2 from the level of the first storage voltage Vcst1. That is, the level of the storage signal may be increased to the level of the second storage voltage Vcst2 from the level of the first storage voltage Vcst1.

The first and second pixel electrodes PE1 and PE2 and the storage electrode STE form first and second boost capacitors. Thus, the voltage level of the first and second pixel electrodes PE1 and PE2 is boosted up by the first and second boost capacitors from the first data voltage by a level difference between the first and second storage voltages Vcst1 and Vcst2. As a result, the pixel PX displays the white gray scale corresponding to the voltage level of the first and second pixel electrodes PE1 and PE2.

When each pixel PX displays the black gray scale, each pixel PX receives the second data voltage in response to the first and second gate signals sequentially provided through the first and second gate lines GLi_1 and GLi_2. Therefore, the second data voltage is applied to the first and second pixel electrodes PE1 and PE2.

The storage signal is maintained in the level of the second storage voltage Vcst2 while each pixel PX receives the second data voltage in response to the first and second gate signals. After the second data voltage is applied to the second pixel electrode PE2, the storage signal is changed to the level of the first storage voltage Vcst1 from the level of the second storage voltage Vcst2. That is, the level of the storage signal may be decreased to the level of the first storage voltage Vcst1 from the level of the second storage voltage Vcst2.

Accordingly, the voltage level of the first and second pixel electrodes PE1 and PE2 is boosted down by the first and second boost capacitors from the second data voltage by the level difference between the first and second storage voltages Vcst1 and Vcst2. As a result, the pixel PX displays the black gray scale corresponding to the voltage level of the first and second pixel electrodes PE1 and PE2.

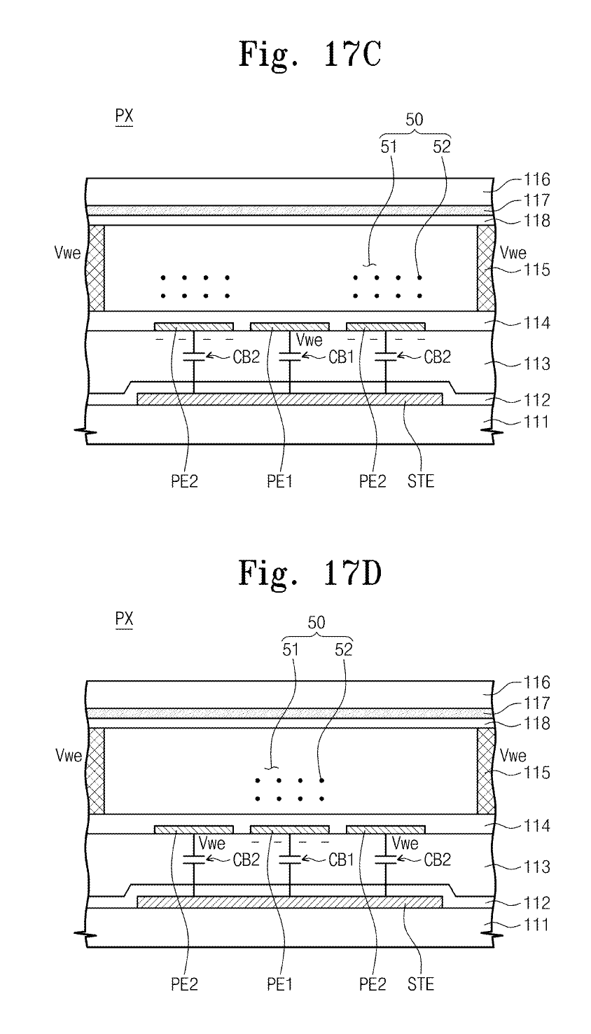

The second data voltage may include first and second sub-data voltages having different levels from each other. The operation of each pixel PX in accordance with the first and second sub-data voltages will be described with reference to FIG. 17B. The second data voltage may be applied to only one of the first pixel electrode PE1 and the second pixel electrode PE2, and this operation will be described in detail with reference to FIGS. 17C and 17D.

With reference to the configuration and the operation of the above-mentioned electrophoresis display apparatus 300, the voltage level of the first and second pixel electrodes PE1 and PE2 of each pixel PX is boosted by the first and second boost capacitors. Accordingly, the electrophoresis display apparatus 300 is operated using the low data voltage in the same way as when the electrophoresis display apparatus 300 is operated using the high data voltage. Consequently, the electrophoresis display apparatus 300 according to the present exemplary embodiment may be operated by using the data driver at the low price, and thus the manufacturing cost of the electrophoresis display apparatus 300 may be reduced.

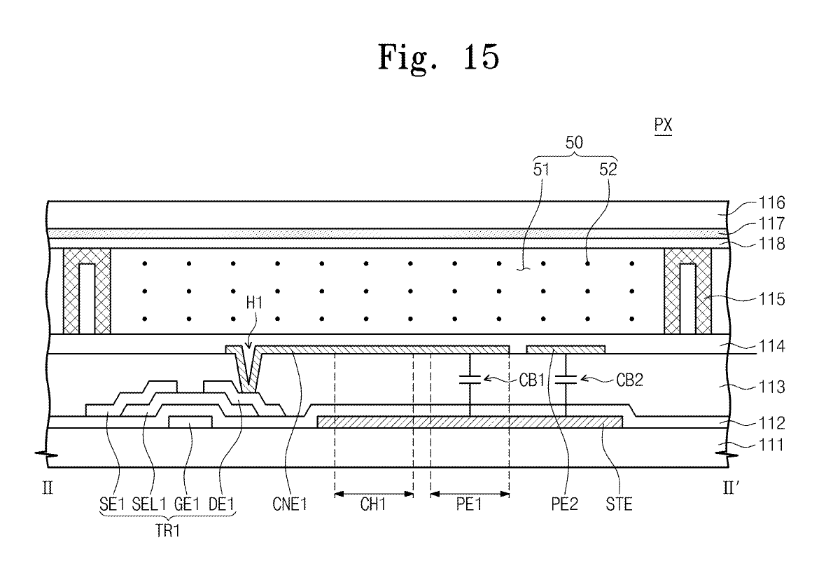

FIG. 14 is a layout showing a pixel shown in FIG. 12.

The pixels shown in FIG. 12 have the same configuration and function, and thus, for the convenience of explanation, one pixel has been shown in FIG. 14.

Referring to FIG. 14, the pixel PX includes first and second gate lines GLi_1 and GLi_2, the storage line SLi, the data line DLj, the first and second thin film transistors TR1 and TR2, the first and second pixel electrodes PE1 and PE2, the first channel area CH1, and the storage electrode STE.

The first and second gate lines GLi_1 and GLi_2 are extended in a first direction D1. The storage line SLi is extended substantially parallel to the first and second gate lines GLi_1 and GLi_2 and disposed between the first and second gate lines GLi_1 and GLi_2. The data line DLj is extended in a second direction D2 substantially perpendicular to the first direction D1 and insulated from the first and second gate lines GLi_1 and GLi_2 and the storage line SLi while crossing the first and second gate lines GLi_1 and GLi_2 and the storage line SLi.

The first thin film transistor TR1 includes a first gate electrode GE1 branched from the first gate line GLi_1, a first source electrode SE1 branched from the data line DLj, and a first drain electrode DE1 electrically connected to a first connection electrode CNE1 branched from the first pixel electrode PE1 through a first contact hole H1. The storage electrode STE is branched from the storage line SL. The first connection electrode CNE1 is formed to pass through the first channel area CH1.

The second pixel electrode PE2 is not formed in the first channel area CH1, and the first channel area CH1 has a width wider than that of the first connection electrode CNE1.

The second thin film transistor TR2 includes a second gate electrode GE2 branched from the second gate line GLi_2, a second source electrode SE2 branched from the data line DLj, and a second drain electrode DE2 electrically connected to a second connection electrode CNE2 branched from the second pixel electrode PE2 through a second contact hole H2.

The first and second pixel electrodes PE1 and PE2 are overlapped with the storage electrode STE, and the storage electrode STE has an area wider than a sum of an area of the first pixel electrode PE1 and an area of the second pixel electrode PE2.

The first pixel electrode PE1 is formed in the center area of the pixel PX, and the second pixel electrode PE2 is formed in the area except the center area to surround the first pixel electrode PE1 and spaced apart from the first pixel electrode PE1.

The barrier wall electrode 115 that partitions the pixels PX is formed along the gate line of a previous pixel, the first gate line of a present pixel adjacent to the previous pixel, and the data lines DL1 to DLm.

FIG. 15 is a cross-sectional view taken along a line II-II′ shown in FIG. 14 and FIG. 16 is a cross-sectional view taken along a line II1-II1′ shown in FIG. 14.

FIG. 15 shows a connection between the first thin film transistor and the first pixel electrode and FIG. 16 shows a connection between the second thin film transistor and the second pixel electrode.

The configuration of the pixel shown in FIGS. 15 and 16 is substantially the same as the configuration of the pixel of the electrophoresis display apparatus according to the second exemplary embodiment except the connection configuration between the first and second thin film transistors TR1 and TR2 and the first and second pixel electrodes PE1 and PE2 and the configuration of the first and second boost capacitors. Therefore, in FIGS. 15 and 16, the same reference numerals denote the same elements in the second exemplary embodiment, and thus the different configurations from the configurations of the pixel of the electrophoresis display apparatus according to the second exemplary embodiment will be described.

Referring to FIG. 15, the first drain electrode DE1 of the first thin film transistor TR1 is electrically connected to the first connection electrode CNE1 branched from the first pixel electrode PE1 through the first contact hole H1 formed through the protective layer 113. The first connection electrode CNE1 is formed to pass through the first channel area CH1.

The second pixel electrode PE2 is not formed in the first channel area CH1. The first and second pixel electrodes PE1 and PE2 are formed to overlap with the storage electrode STE.

The first boosting capacitor CB1 is formed by the first pixel electrode PE1 and the storage electrode STE branched from the storage line SLi.

The second boosting capacitor CB2 is formed by the second pixel electrode PE2 and the storage electrode STE branched from the storage line SLi.

Referring to FIG. 16, the second drain electrode DE2 of the second thin film transistor TR2 is electrically connected to the second connection electrode CNE2 branched from the second pixel electrode PE2 through the second contact hole H2 formed through the protective layer 113.

FIGS. 17A to 17D are cross-sectional views taken along a line II2-II2′ shown in FIG. 14.

FIG. 17A shows the movement of the electrophoretic particles of the pixel that displays the white gray scale, and FIG. 17B shows the movement of the electrophoretic particles of the pixel that displays the black gray scale. FIGS. 17C and 17D show the movement of the electrophoretic particles of the pixel that displays the intermediate gray scales.

Referring to FIG. 17A, the first data voltage is applied to the first and second pixel electrodes PE1 and PE2 of the pixel PX. The voltage level of the first and second pixel electrodes PE1 and PE2 is boosted up by the first and second boost capacitors CB1 and CB2 from the level of the first data voltage by the level difference between the first and second storage voltages Vcst1 and Vcst2. Since this operation has been already described, details thereof will be omitted.

The resist electrode 117 is maintained in the first data voltage having the positive (+) polarity and the barrier wall electrode 115 is applied with the barrier wall voltage. In this case, as shown in FIG. 17A, the first and second pixel electrodes PE1 and PE2 have the positive (+) polarity and the barrier wall electrode 115 has the negative (−) polarity.

Accordingly, the attractive force acts between the barrier wall electrode 115 and the electrophoretic particles 52 by the electric field generated between the barrier wall electrode 115 and the first and second pixel electrodes PE1 and PE2 and the electric field generated between the barrier wall electrode 115 and the resist electrode 117. As a result, the electrophoretic particles 52 move to the barrier wall electrode 115.

When the electrophoretic particles 52 move to the barrier wall electrode 115, the pixel PX displays the white gray scale. The operation displaying the white gray scale during the one frame set has been already described, so details thereof will be omitted.

Referring to FIG. 17B, when the pixel PX displays the black gray scale, the second data voltage is applied to the first and second pixel electrodes PE1 and PE2 of the pixel PX. The voltage level of the first and second pixel electrodes PE1 and PE2 is boosted down by the first and second boost capacitors CB1 and CB2 from the level of the second data voltage by the level difference between the first and second storage voltages Vcst1 and Vcst2.

The second data voltage includes the first and second sub-data voltages. The first sub-data voltage has the level lower than that of the second sub-data voltage.

The first sub-data voltage is applied to the first pixel electrode PE1 through the first thin film transistor turned on by the first gate signal. The second sub-data voltage is applied to the second pixel electrode PE2 through the second thin film transistor turned on by the second gate signal.

As an example, the level of the first sub-data voltage is set to about −10 volts and the level of the second sub-data voltage is set to about −7.5 volts.

In the case that the first storage voltage Vcst1 has the voltage level of about −5 volts and the second storage voltage Vcst2 has the voltage level of about +5 volts, the voltage level of the first pixel electrode PE1 is lowered to −20 volts from −10 volts by the first boost capacitor CB1. In addition, the voltage level of the second pixel electrode PE2 is lowered to −17.5 volts from −7.5 volts by the second boost capacitor CB2.

A distance between the barrier wall electrode 115 and the first pixel electrode PE1 is longer than a distance between the barrier wall electrode 115 and the second pixel electrode PE2. Thus, when the first and second pixel electrodes PE1 and PE2 are applied with the same voltage, the intensity of the electric field generated between the barrier wall electrode 115 and the first pixel electrode PE1 may be weaker than the intensity of the electric field generated between the barrier wall electrode 115 and the second pixel electrode PE2. In this case, the electrophoretic particles 52 may not be gathered onto the center area of the pixel.

However, the voltage level of the second pixel electrode PE2 is higher than the voltage level of the first pixel electrode PE1. Thus, the intensity of the electric field generated between the barrier wall electrode 115 and the second pixel electrode PE2 becomes weaker than that when the first and second pixel electrodes PE1 and PE2 are applied with the same voltage.

As an example, when the voltage of about −10 volts, which is equal to the voltage applied to the first pixel electrode PE1, is applied to the second pixel electrode PE2, the second pixel electrode PE2 is lowered to about −20 volts by the second boost capacitor CB2. When the level of the voltage applied to the barrier wall electrode 115 is 0 volts, the voltage level difference between the barrier wall electrode 115 and the second pixel electrode PE2 is about 20 volts. However, since the voltage level of the second pixel electrode PE2 is about −17.5 volts in the present exemplary embodiment, the voltage level difference between the barrier wall electrode 115 and the second pixel electrode PE2 is about 17.5 volts. Therefore, the intensity of the electric field generated between the barrier wall electrode 115 and the second pixel electrode PE2 becomes relatively weaker than that when the first and second pixel electrodes PE1 and PE2 are applied with the same voltage.

Accordingly, the intensity of the electric field generated between the barrier wall electrode 115 and the first pixel electrode PE1 becomes substantially the same as the intensity of the electric field generated between the barrier wall electrode 115 and the second pixel electrode PE2. As a result, the electrophoretic particles 52 may be uniformly distributed on the pixel electrode PE as shown in FIG. 17B.

A vertical electric field may be generated between the resist electrode 117 and the first and second pixel electrodes PE1 and PE2. As described with reference to FIG. 10B, however, the electrophoretic particles 52 may be stayed on the first and second pixel electrodes PE1 and PE2 without moving by the vertical electric field generated between the resist electrode 117 and the first and second pixel electrodes PE1 and PE2.

Consequently, each pixel PX may display the black gray scale normally, thereby improving the contrast ratio of the image displayed thereon.

Referring to FIG. 17C, the electrophoretic particles 52 may move onto the second pixel electrode PE2 of the pixel PX. For instance, after the pixel PX is reset, the first pixel electrode PE1 receives the first data voltage and the second pixel electrode PE2 receives the second data voltage. The voltage level of the second pixel electrode PE2 is lowered by the second boost capacitor CB2 from the voltage level of the second data voltage by the level difference between the first and second storage voltages Vcst1 and Vcst2. Accordingly, the electrophoretic particles 52 move onto the second pixel electrode PE2 by the electric field generated between the barrier wall electrode 115 and the second pixel electrode PE2.

According to the operation of the pixel described with reference to FIG. 11, however, the voltage level of the first pixel electrode PE1 applied with the first data voltage may become substantially the same as the voltage level of the barrier wall electrode 115 by the first boost capacitor CB 1. Thus, the electrophoretic particles 52 do not move onto the first pixel electrode PE.

Referring to FIG. 17D, the electrophoretic particles 52 may move onto the first pixel electrode PE1 of the pixel PX. For instance, after the pixel PX is reset, the first pixel electrode PE1 is applied with the second data voltage and the second pixel electrode PE2 is applied with the first data voltage. The operation of the pixel when the second data voltage is applied to the first pixel electrode PE1 is substantially the same as the operation of the pixel when the second data voltage is applied to the second pixel electrode PE2 as described in FIG. 17C. Therefore, the electrophoretic particles 52 move onto the first pixel electrode PE1 by the electric field generated between the barrier wall electrode 115 and the first pixel electrode PE1.

The operation of the pixel when the first data voltage is applied to the second pixel electrode PE2 is substantially the same as the operation of the pixel when the first data voltage is applied to the first pixel electrode PE1 in FIG. 17C.

Consequently, the electrophoretic particles 52 may move onto the first pixel electrode PE1 or the second pixel electrode PE2. Accordingly, each pixel PX of the electrophoresis display apparatus 300 according to the third exemplary embodiment may display various intermediate gray scales besides the intermediate gray scales of 1 to 39 steps when the one frame set is configured to include 40 frames.

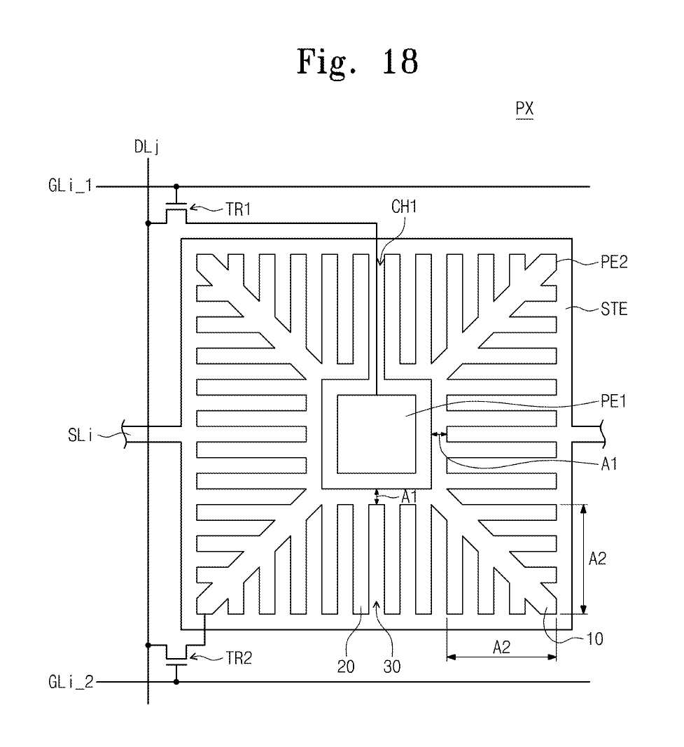

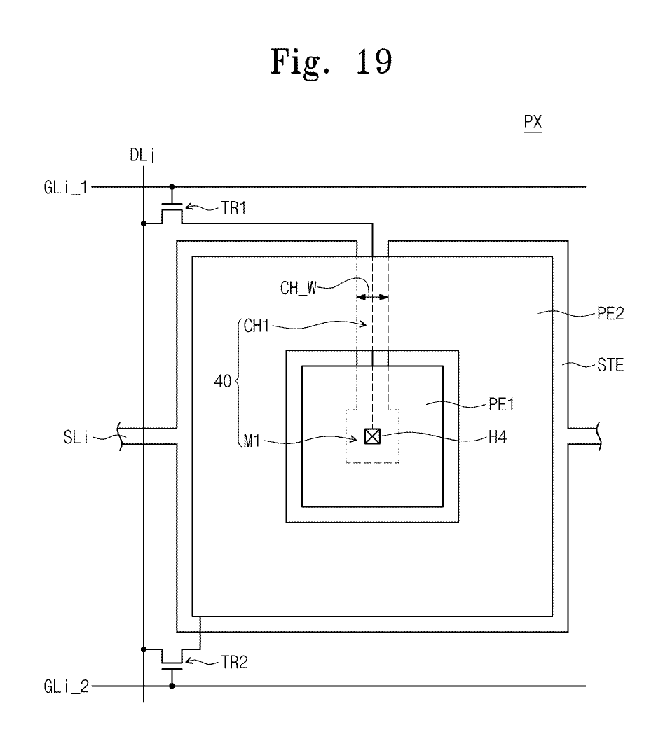

FIG. 18 is a plan view showing a pixel of an electrophoresis display apparatus according to a fourth exemplary embodiment of the present invention. The pixel shown in FIG. 19 has substantially the same configuration as the pixel shown in FIG. 13 except that the second pixel electrode PE2 is formed in the feather pattern.

Referring to FIG. 18, the second pixel electrode PE2 is spaced apart from the first pixel electrode PE1 to surround the first pixel electrode PE1 and formed in the area except the first channel area CH1.

The second pixel electrode PE2 includes a first area A1 having a rectangular band shape and surrounding the first pixel electrode PE1, a plurality of first branch portions 10 protruded from each vertex of the first area A1, and a plurality of second branch portions 20 protruded from four sides of the first area A1 and the first branch portions 10.

Areas between the second branch portions 20 may be defined as slit areas 30. In addition, an area of the second pixel electrode PE2, which includes the first branch portions 10, the second branch portions 20, and the slit areas 30, may be defined as a second area A2.

A second drain electrode of the second thin film transistor TR2 is electrically connected to a second connection electrode branched from one of the first branch portions 10 or one of the second branch portions 20. As an example, the drain electrode of the second thin film transistor TR2 is connected to the connection electrode branched from one of the first branch portions 10 of the second pixel electrode PE2.

In case of the black gray scale, the second data voltage is applied to the first and second pixel electrodes to display the black gray scale. The second data voltage does not need to include both of the first sub-data voltage and the second sub-data voltage. That is, the data voltage having the different level from the data voltage applied to the first pixel electrode is applied to the second pixel electrode shown in FIG. 13, but the data voltage having the same level as the data voltage applied to the first pixel electrode is applied to the second pixel electrode PE2 shown in FIG. 18.

According to the operation of the pixel described with reference to FIG. 8B, the intensity of the electric field generated between the first pixel electrode PE1 and the barrier wall electrode 115 may be weaker than the intensity of the electric field generated between the second pixel electrode PE2 and the barrier wall electrode when the second pixel electrode PE2 is not formed in the feather pattern. Accordingly, the intensity of the electric field generated between the barrier wall electrode 115 and the first pixel electrode PE1 may become substantially the same as the intensity of the electric field between the barrier wall electrode 115 and the second pixel electrode PE2. As a result, the electrophoretic particles 52 are uniformly distributed on the first and second pixel electrodes PE1 and PE2, so that the black gray scale may be displayed.

The operation of the pixel PX, in which the white gray scale is displayed, is substantially the same as the operation of the pixel of the electrophoresis display apparatus 300 according to the third exemplary embodiment, so that detailed descriptions of the operation of the pixel PX when the white gray scale is displayed will be omitted. In addition, since the operation of the pixel, in which the intermediate gray scales are displayed by moving the electrophoretic particles 52 onto the first pixel electrode PE1 or the second pixel electrode PE2, is substantially the same as the operation of the pixel of the electrophoresis display apparatus 300 according to the third exemplary embodiment, detailed descriptions of the operation of the pixel for the intermediate gray scales will be omitted.

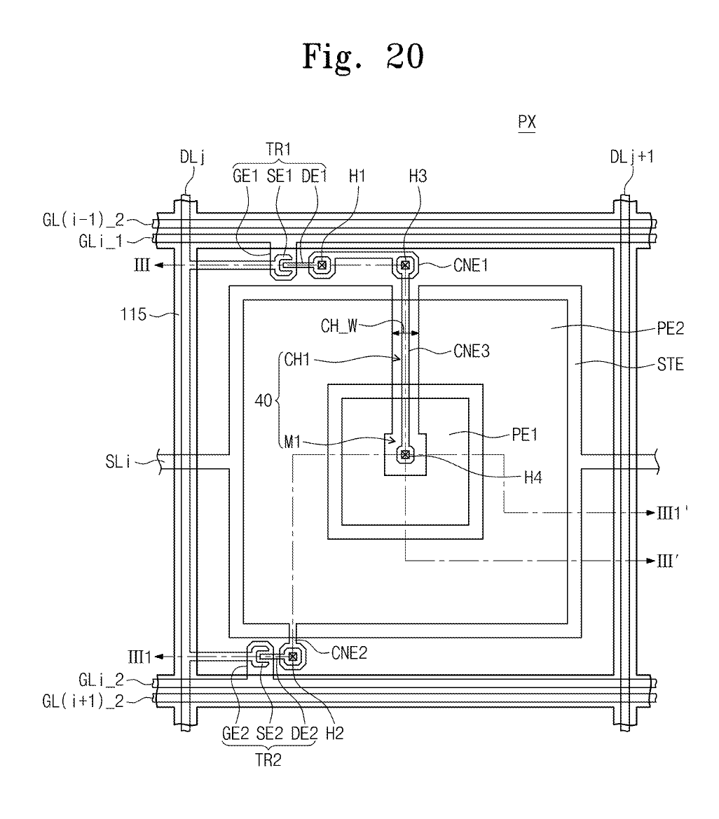

FIG. 19 is a plan view showing a pixel of an electrophoresis display apparatus according to a fifth exemplary embodiment of the present invention and FIG. 20 is a layout showing a pixel shown in FIG. 19.

The pixel shown in FIGS. 19 and 20 has substantially the same configuration as the pixel shown in FIGS. 13 and 14 except the configurations of the storage electrode and the pixel electrode and the connection configuration between the pixel electrode and the thin film transistor. Accordingly, hereinafter, the different configurations from the configurations of the pixel shown in FIGS. 13 and 14 will be mainly described.

Referring to FIG. 19, a first drain electrode of a first thin film transistor TR1 is electrically connected to the first pixel electrode PE1, and a second drain electrode of a second thin film transistor TR2 is electrically connected to the second pixel electrode PE2.

The storage electrode STE includes a first slit area 40. The first pixel electrode PE1 is connected to the first drain electrode of the first thin film transistor TR1 in the first slit area 40. The configuration of the first slit area 40 and the connection configuration between the first drain electrode of the first thin film transistor TR1 and the first pixel electrode PE1 will be described in detail with reference to FIG. 20 later.

The storage electrode STE branched from the storage line SLi is formed to overlap with the first and second pixel electrodes PE1 and PE2 in the area except the first slit area 40.

The first pixel electrode PE1 is formed in the center area of the pixel PX. The second pixel electrode PE2 is spaced apart from the first pixel electrode PE1 to surround the first pixel electrode PE1. The other configurations of the pixel PX are substantially the same as those of the pixel shown in FIG. 13.

Referring to FIG. 20, the first drain electrode DE1 of the first thin film transistor TR1 is electrically connected to the first connection electrode CNE1 through a first contact hole H1. The first connection electrode CNE1 is electrically connected to a third connection electrode CNE3 through a third contact hole H3. The first pixel electrode PE1 is electrically connected to the third connection electrode CNE3 through a fourth contact hole H4.

The storage electrode includes the first slit area 40. The first slit area 40 includes a first channel area CH1 through which the third connection electrode CNE3 passes and a first center area M1 providing the fourth contact hole H4 through which the first pixel electrode PE1 and the third connection electrode CNE3 are connected to each other. The first center area M1 has a rectangular shape.

The first center area M1 has a width wider than a width CH_W of the first channel area CH1. The storage electrode STE is not formed in the first slit area 40, and the first slit area 40 is formed larger than the third connection electrode CNE3 such that the storage electrode STE is not overlapped with the third connection electrode CNE3. For instance, the width CH_W of the first channel area CH1 and the width of the first center area M1 are larger than the width of the third connection electrode CNE3.

The storage electrode STE branched from the storage line SLi is formed to overlap with the first and second pixel electrodes PE1 and PE2 in the area except the first slit area 40.

The second drain electrode DE2 of the second thin film transistor TR2 is electrically connected to the second connection electrode CNE2 branched from the second pixel electrode PE2 through the second contact hole H2.

The first pixel electrode PE1 is formed in the center area of the pixel PX, and the second pixel electrode PE2 is formed to surround the first pixel electrode PE1 and spaced apart from the first pixel electrode PE1. The other configurations of the pixel PX are substantially the same as those of the pixel shown in FIG. 14.

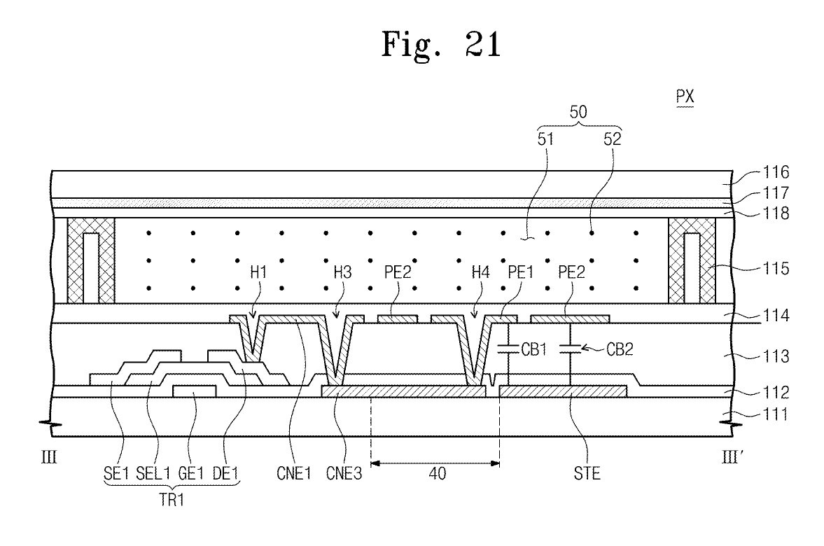

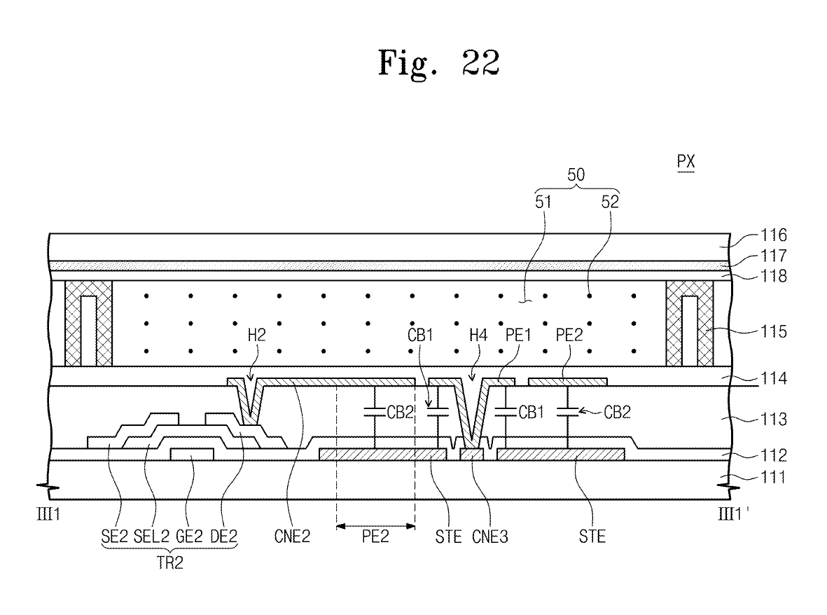

FIG. 21 is a cross-sectional view taken along a line III-III′ shown in FIG. 20 and FIG. 22 is a cross-sectional view taken along a line III1-III1′ shown in FIG. 20.

FIG. 21 shows the connection configuration between the first thin film transistor and the first pixel electrode, and FIG. 22 shows the connection configuration between the second thin film transistor and the second pixel electrode.

The configuration of the pixel shown in FIGS. 21 and 22 is substantially the same as the pixel of the electrophoresis display apparatus according to third exemplary embodiment except the connection configuration between the first and second thin film transistors TR1 and TR2 and the first and second pixel electrodes PE1 and PE2, the configuration of the storage electrode, and the configuration of the second pixel electrode.

Accordingly, in FIGS. 21 and 22, the same reference numerals denote the same elements according to the third exemplary embodiment, and thus detailed descriptions of the same elements will be omitted. Hereinafter, the different configurations from the configurations of the pixel of the electrophoresis display apparatus according to the third exemplary embodiment will be described, and the other configurations of the pixel will be omitted.

Referring to FIG. 21, the third connection electrode CNE3 and the storage electrode STE are formed on the first base substrate 111, and the third connection electrode CNE3 is formed in the first slit area 40.

The first drain electrode DE1 of the first thin film transistor TR1 is electrically connected to the first connection electrode CNE1 through the first contact hole H1 formed through the protective layer 113. The first connection electrode CNE1 is electrically connected to the third connection electrode CNE3 through a third contact hole H3 formed through the protective layer 113. The first pixel electrode PE1 is electrically connected to the third connection electrode CNE3 through a fourth contact hole H4 formed through the protective layer 113. Accordingly, the first pixel electrode PE1 may be applied with the data voltage.

The second pixel electrode PE2 is spaced apart from the first pixel electrode PE1 to surround the first pixel electrode PE1. The first and second pixel electrodes PE1 and PE2 are overlapped with the storage electrode STE in the area except the first slit area 40.

The first pixel electrode PE1 and the storage electrode STE form the first boost capacitor CB1. The second pixel electrode PE2 and the storage electrode STE form the second boost capacitor CB2.

Referring to FIG. 22, the second drain electrode DE2 of the second thin film transistor TR2 is electrically connected to the second connection electrode CNE2 branched from the second pixel electrode PE2 through the second contact hole H2 formed through the protective layer 113.

The pixel of the electrophoresis display apparatus according to the fifth exemplary embodiment is configured to include the first pixel electrode PE1 and the second pixel electrode PE2 to receive the data voltage and display the gray scales. Thus, the operation of the pixel PX of the electrophoresis display apparatus according to the fifth exemplary embodiment, which displays the white gray scale, the black gray scale, and the intermediate gray scales, is substantially the same as the operation of the pixel of the electrophoresis display apparatus according to the third exemplary embodiment shown in FIG. 13.

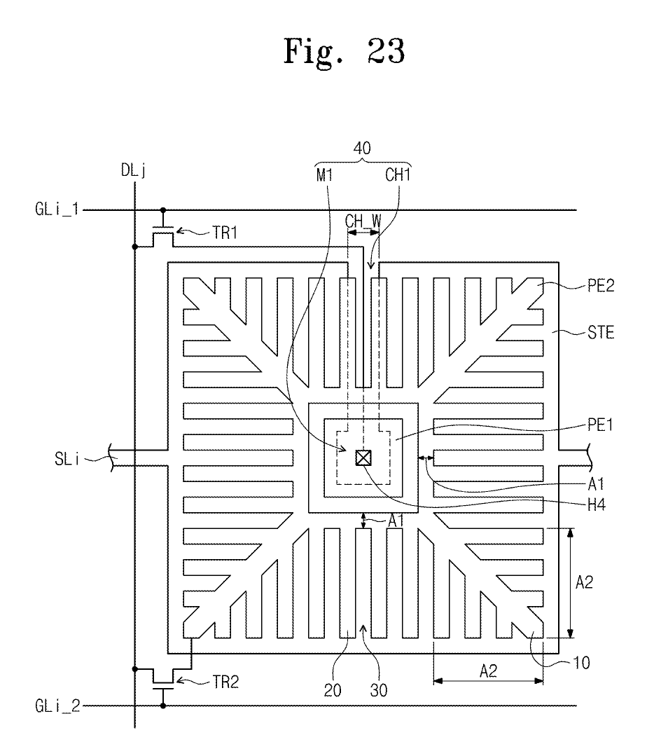

FIG. 23 is a plan view showing a pixel of an electrophoresis display apparatus according to a sixth exemplary embodiment of the present invention.

Referring to FIG. 23, the second pixel electrode PE2 is spaced apart from the first pixel electrode PE1 and formed to surround the first pixel electrode PE1. The second pixel electrode PE2 has the feather pattern.

The pixel shown in FIG. 23 has substantially the same configuration as the pixel shown in FIG. 19 except the second pixel electrode PE2.

The second pixel electrode PE2 has a rectangular band shape and includes a first area A1 surrounding the first pixel electrode PE1 and a second area A2 branched from the first area A1.

The second area A2 includes a plurality of first branch portions 10 protruded from each vertex of the first area A1, a plurality of second branch portions 20 protruded from four sides of the first area A1 and the first branch portions 10, and a plurality of slit areas 30 defined as areas between the second branch portions 20. The second pixel electrode PE2 is not formed in the slit areas 30.

The operation of the pixel PX of the electrophoresis display apparatus shown in FIG. 23, which displays the white gray scale, the black gray scale, and the intermediate gray scales, is substantially the same as the operation of the pixel of the electrophoresis display apparatus according to the fourth exemplary embodiment shown in FIG. 18.

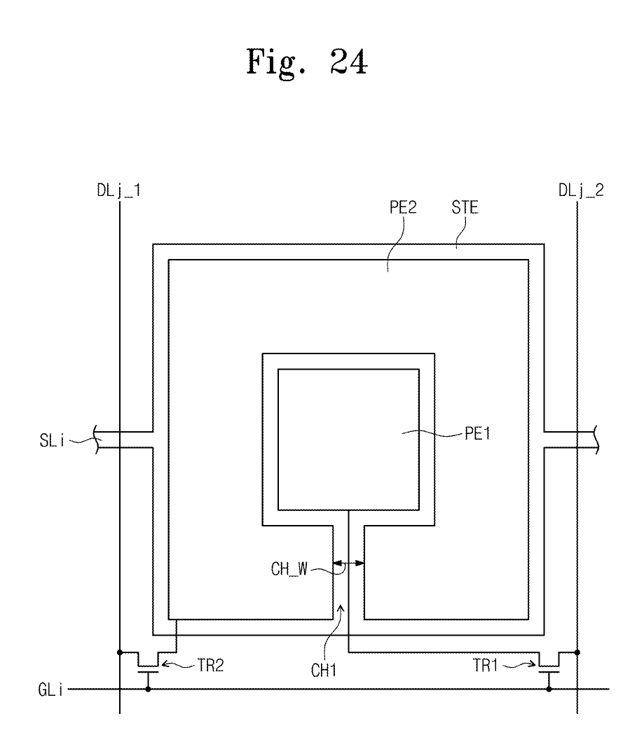

FIG. 24 is a plan view showing a pixel of an electrophoresis display apparatus according to a seventh exemplary embodiment of the present invention.

The pixel of the electrophoresis display apparatus shown in FIG. 24 has substantially the same configuration as the pixel according to the third exemplary embodiment shown in FIGS. 13 and 14 except that the pixel is connected to a corresponding gate line and corresponding first and second data lines.

Accordingly, the configurations of the pixel of the electrophoresis display apparatus according to the seventh exemplary embodiment, which are different from the pixel of the electrophoresis display apparatus shown in FIGS. 13 and 14, will be described in detail, and the other configurations thereof will be omitted.

Referring to FIG. 24, the data voltages are applied to the pixels through the data lines configured to include first data lines and second data lines.

The first thin film transistor TR1 includes a source electrode electrically connected to the second data line DLj_2 and a drain electrode electrically connected to the first pixel electrode PE1. The configuration in which the drain electrode of the first thin film transistor TR1 is connected to the first pixel electrode PE1 is substantially the same as the pixel shown in FIG. 14.

The second thin film transistor TR2 includes a source electrode electrically connected to the first data line DLj_1 and a drain electrode electrically connected to the second pixel electrode PE2. The configuration in which the drain electrode of the second thin film transistor TR2 is connected to the second pixel electrode PE2 is substantially the same as the pixel shown in FIG. 14.

A gate electrode of each of the first and second thin film transistors TR1 and TR2 is electrically connected to the gate line GLi.

The first pixel electrode PE1 of the pixel PX is connected to the first data line DLj_1 through the first thin film transistor TR1 that is turned on in response to the gate signal provided through the gate line GLi. Accordingly, the first pixel electrode PE1 of the pixel PX receives the data voltage through the first data line DLj_1.

The second pixel electrode PE2 of the pixel PX is connected to the second data line DLj_2 through the second thin film transistor TR2 that is turned on in response to the gate signal provided through the gate line GLi. Accordingly, the second pixel electrode PE2 of the pixel PX receives the data voltage through the second data line DLj_2.

The data voltage includes a first data voltage used to display the white gray scale and a second data voltage used to display the black gray scale. In addition, the second data voltage includes a first sub-data voltage and a second sub-data voltage, which have different levels from each other.

When the pixel PX displays the white gray scale, the pixel PX receives the first data voltage through the first and second data liens DLj_1 and DLj_2 in response to the gate signal provided through the gate line GLi. Thus, the first data voltage is applied to the first and second pixel electrodes PE1 and PE2.

The storage signal may be maintained in the level of the first storage voltage Vcst1 while the pixel PX receives the first data voltage in response to the gate signal. After the first data voltage is applied to the first and second pixel electrodes PE1 and PE2, the storage signal is changed to the level of the second storage voltage Vcst2 from the level of the first storage voltage Vcst1. That is, the storage signal may be increased to the level of the second storage voltage Vcst2 from the level of the first storage voltage Vcst1.

Then, the boosting operation and the operation of the pixel PX to display the white gray scale is substantially the same as the operation of the pixel of the electrophoresis display apparatus according to the third exemplary embodiment shown in FIG. 13, and thus details thereof will be omitted.

When the pixel PX displays the black gray scale, the pixel PX receives the second data voltage through the first and second data liens DLj_1 and DLj_2 in response to the gate signal provided through the gate line GLi. Thus, the second data voltage is applied to the first and second pixel electrodes PE1 and PE2.

The storage signal may be maintained in the level of the second storage voltage Vcst2 while the pixel PX receives the second data voltage in response to the gate signal. After the second data voltage is applied to the first and second pixel electrodes PE1 and PE2, the storage signal is changed to the level of the first storage voltage Vcst1 from the level of the second storage voltage Vcst2. That is, the storage signal may be decreased to the level of the first storage voltage Vcst1 from the level of the second storage voltage Vcst2.

Then, the boosting operation and the operation of the pixel PX to display the black gray scale is substantially the same as the operation of the pixel of the electrophoresis display apparatus according to the third exemplary embodiment shown in FIG. 13, and thus details thereof will be omitted.

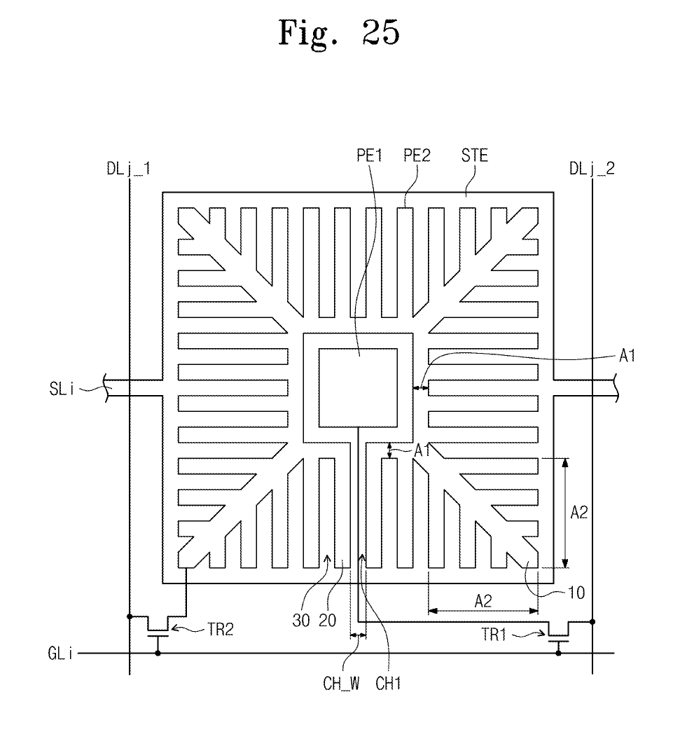

FIG. 25 is a plan view showing a pixel of an electrophoresis display apparatus according to an eighth exemplary embodiment of the present invention.

The configuration of the pixel shown in FIG. 25 is substantially the same as the pixel shown in FIG. 24 except the configuration of the second pixel electrode. In addition, the configuration of the second pixel electrode is substantially the same as the configuration of the second pixel electrode shown in FIG. 18.

Further, the connection configuration between the first pixel electrode and the drain electrode of the first thin film transistor and the connection configuration between the second pixel electrode and the drain electrode of the second thin film transistor of the pixel shown in FIG. 25 are substantially the same as the connection configuration between the first pixel electrode and the drain electrode of the first thin film transistor and the connection configuration between the second pixel electrode and the drain electrode of the second thin film transistor of the pixel shown in FIG. 18. Thus, detailed descriptions of the configuration of the pixel shown in FIG. 25 will be omitted.

The operation of the pixel shown in FIG. 25 according to the data voltage applied thereto is substantially the same as the operation of the pixel of the electrophoresis display apparatus according to the fourth exemplary embodiment shown in FIG. 18.

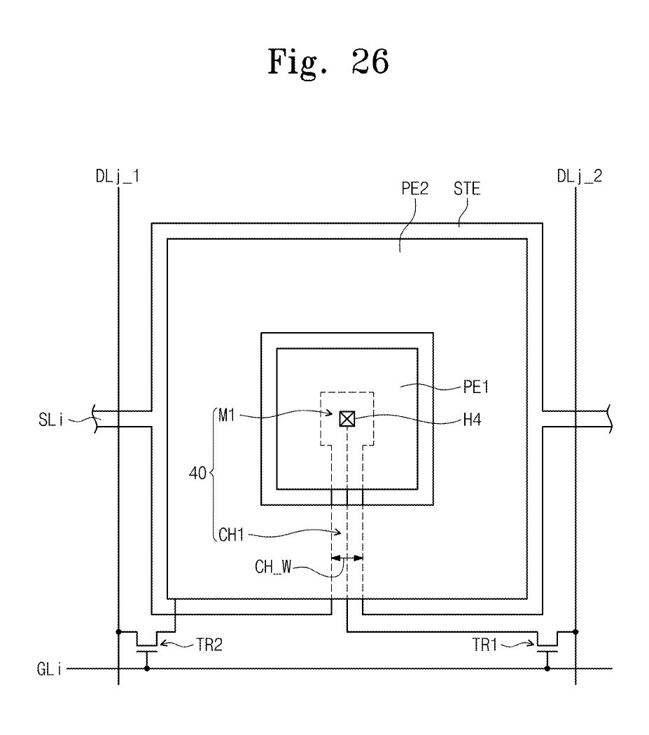

FIG. 26 is a plan view showing a pixel of an electrophoresis display apparatus according to a ninth exemplary embodiment of the present invention.

The configuration of the pixel, which is connected to the corresponding gate line and the corresponding first and second data lines, shown in FIG. 26 is substantially the same as the configuration of the pixel shown in FIG. 24.

In addition, configurations of first and second pixel electrodes of the pixel shown in FIG. 26 are substantially the same as those of the first and second pixel electrodes of the electrophoresis display apparatus according to the fifth exemplary embodiment shown in FIG. 19.

Further, the connection configuration between the first pixel electrode and the drain electrode of the first thin film transistor and the connection configuration between the second pixel electrode and the drain electrode of the second thin film transistor of the pixel shown in FIG. 26 are substantially the same as the connection configuration between the first pixel electrode and the drain electrode of the first thin film transistor and the connection configuration between the second pixel electrode and the drain electrode of the second thin film transistor of the pixel shown in FIG. 20. Accordingly, detailed descriptions of the configuration of the pixel shown in FIG. 26 will be omitted.

The operation of the pixel shown in FIG. 26 according to the data voltage applied thereto is substantially the same as the operation of the pixel of the electrophoresis display apparatus according to the fifth exemplary embodiment shown in FIG. 19.

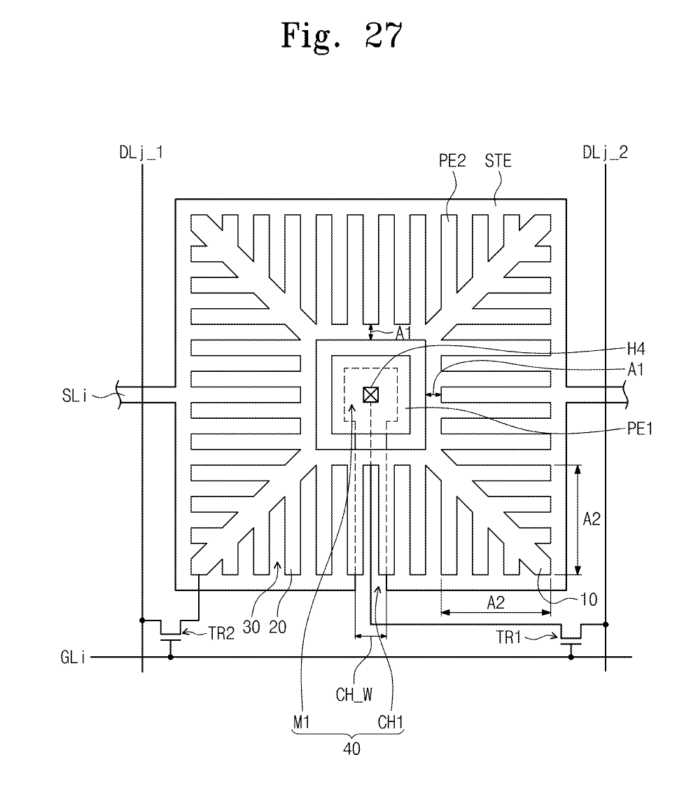

FIG. 27 is a plan view showing a pixel of an electrophoresis display apparatus according to a tenth exemplary embodiment of the present invention.

The configuration of the pixel shown in FIG. 27 is substantially the same as that of the pixel shown in FIG. 26 except the configuration of the second pixel electrode. In addition, the configuration of the second pixel electrode shown in FIG. 27 is substantially the same as that of the second pixel electrode shown in FIG. 23.

Further, the connection configuration between the first pixel electrode and the drain electrode of the first thin film transistor and the connection configuration between the second pixel electrode and the drain electrode of the second thin film transistor of the pixel shown in FIG. 27 are substantially the same as the connection configuration between the first pixel electrode and the drain electrode of the first thin film transistor and the connection configuration between the second pixel electrode and the drain electrode of the second thin film transistor of the pixel shown in FIG. 23. Accordingly, detailed descriptions of the configuration of the pixel shown in FIG. 27 will be omitted.

The operation of the pixel shown in FIG. 27 according to the data voltage applied thereto is substantially the same as that of the pixel of the electrophoresis display apparatus according to the sixth exemplary embodiment shown in FIG. 23.

Consequently, the electrophoresis display apparatus according to the exemplary embodiments may be operated by using the data driver at the low price. Thus, the manufacturing cost of the electrophoresis display apparatus may be reduced, the contrast ratio of the image displayed on the electrophoresis display apparatus may be improved, and the electrophoresis display apparatus may display various intermediate gray scales.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. An electrophoresis display apparatus comprising:
a display panel that includes a plurality of pixels;
a gate driver that is configured to sequentially apply gate signals to the pixels through a plurality of gate lines;
a storage driver that is configured to sequentially apply storage voltages to the pixels through a plurality of storage lines; and
a data driver that is configured to apply data voltages to the pixels through a plurality of data lines, each of the pixels comprising:
a boost capacitor include a pixel electrode, a storage electrode and an insulating layer interposed between the pixel electrode and the storage electrode; and
a thin film transistor that apply a corresponding data voltage of the data voltages to the pixel electrode in response to a corresponding gate signal of the gate signals, wherein a level of the storage voltage is changed after the corresponding data voltage is charged to the pixel electrode and a voltage level of the pixel electrode is boosted by the boost capacitor from a level of the corresponding data voltage to a boosted voltage by the change in the level of the storage voltage.

2. The electrophoresis display apparatus of claim 1, wherein the thin film transistor comprises a gate electrode connected to a corresponding gate line of the gate lines, a source electrode connected to a corresponding data line of the data lines, and a drain electrode connected to a connection electrode branched from the pixel electrode.

3. The electrophoresis display apparatus of claim 2, wherein the pixel electrode comprises:
a first area formed in a center area of the pixel electrode;
a plurality of first branch portions extended from the first area toward an each vertex of the pixel electrode; and
a plurality of second branch portions extended from the first area toward each edges of the pixel electrode.

4. The electrophoresis display apparatus of claim 3, wherein the connection electrode is branched from the first branch portions or the second branch portions.

5. The electrophoresis display apparatus of claim 1, wherein the storage voltage comprises a first storage voltage and a second storage voltage having a level higher than a level of the first storage voltage, and the data voltage comprises a first data voltage having a positive polarity and a second data voltage having a negative polarity.

6. The electrophoresis display apparatus of claim 5, further comprising a voltage supplier configured to generate the first and the second storage voltages and apply the first and the second storage voltages to the storage driver.

7. The electrophoresis display apparatus of claim 5, wherein the storage electrode is configured to be applied with the first storage voltage while the first data voltage is applied to the pixel electrode, and the storage electrode is configured to be applied with the second storage voltage after the first data voltage is applied to the pixel electrode.

8. The electrophoresis display apparatus of claim 7, wherein the voltage level of the pixel electrode is configured to be increased by the boost capacitor from the first data voltage to a boosted voltage by a difference in voltage between the first and the second storage voltages, and the pixel configured to display a white gray scale corresponding to the voltage level of the pixel electrode.

9. The electrophoresis display apparatus of claim 5, wherein the storage electrode is configured to be applied with the second storage voltage while the second data voltage is charged to the pixel electrode, and the storage electrode is configured to be applied with the first storage voltage after the second data voltage is charged to the pixel electrode.

10. The electrophoresis display apparatus of claim 9, wherein the voltage level of the pixel electrode is configured to be decreased by the boost capacitor from the second data voltage to a boosted voltage by the difference in voltage between the first and the second storage voltages, and the pixel is configured to display a black gray scale corresponding to the voltage level of the pixel electrode.

11. The electrophoresis display apparatus of claim 5, wherein the display panel comprises:
a first base substrate on which the thin film transistor, the storage electrode, the pixel electrode, an insulating layer formed on the pixel electrode, and a barrier wall electrode disposed on the insulating layer to partition the pixels are disposed, the pixel electrode being connected to a drain electrode of the thin film transistor and overlapped with the storage electrode to form the boost capacitor;
a second base substrate facing the first base substrate and including a resist electrode disposed thereon and applied with the first data voltage,
wherein an electrophoretic material is interposed between the first and the second base substrates and accommodated in a pixel area defined by the barrier wall electrode, and the electrophoretic material comprises a dielectric solvent and electrophoretic particles, which are distributed in the dielectric solvent and charged to a positive electric charge.

12. The electrophoresis display apparatus of claim 11, wherein the storage electrode has an area larger than an area of the pixel electrode when viewed in a plan view.

13. The electrophoresis display apparatus of claim 12, wherein the barrier wall electrode is configured to be applied with a barrier wall voltage having an intermediate level between the first data voltage and the second data voltage.

14. The electrophoresis display apparatus of claim 13, wherein the storage voltage is configured to be maintained in the first storage voltage while the first data voltage is charged to the pixel electrode, the storage voltage is configured to be changed to the second storage voltage after the first data voltage is charged to the pixel electrode, and the electrophoretic particles is configured to move to the barrier wall electrode by an electric field generated between the pixel electrode and the barrier wall electrode and between the resist electrode and the barrier wall electrode.

15. The electrophoresis display apparatus of claim 13, wherein the storage voltage is configured to be maintained in the second storage voltage while the second data voltage is charged to the pixel electrode, the storage voltage is configured to be changed to the first storage voltage after the second data voltage is charged to the pixel electrode, and the electrophoretic particles is configured to move onto the pixel electrode by an electric field generated between the pixel electrode and the barrier wall electrode.

16. An electrophoresis display apparatus comprising:
a display panel that includes a plurality of pixels;
a gate driver that is configured to sequentially apply gate signals to the pixels through a plurality of gate lines including first gate lines and second gate lines;
a storage driver that is configured to sequentially apply storage voltages to the pixels through a plurality of storage lines; and
a data driver that is configured to apply data voltages to the pixels through a plurality of data lines, each of the pixels comprising:
a first pixel electrode disposed in a center area of the pixel;
a second pixel electrode spaced apart from the first pixel electrode and formed to surround the first pixel electrode;
a first boost capacitor including the first pixel electrode, a storage electrode branched from a corresponding storage line of the storage lines, and an insulating layer interposed between the first pixel electrode and the storage electrode;
a second boost capacitor including the second pixel electrode, the storage electrode and the insulating layer interposed between the second pixel electrode and the storage electrode;
a first thin film transistor configured to apply a corresponding data voltage of the data voltages to the first pixel electrode in response to a corresponding gate signal of the gate signals provided through the first gate line; and
a second thin film transistor configured to apply the corresponding data voltage of the data voltages to the second pixel electrode in response to a corresponding gate signal of the gate signals provided through the second gate line, wherein a level of the storage voltage is configured to be changed after the corresponding data voltage is charged to the first and the second pixel electrodes and a voltage level of the first and the second pixel electrodes is configured to be boosted by the first and the second boost capacitors from the corresponding data voltage to a boosted voltage by the change in the level of the storage voltage.

17. The electrophoresis display apparatus of claim 16,
wherein the first thin film transistor comprises:
a first gate electrode connected to a corresponding first gate line of the first gate lines;
a first source electrode connected to a corresponding data line of the data lines; and
a first drain electrode connected to a first connection electrode branched from the first pixel electrode, and
wherein the second thin film transistor comprises:
a second gate electrode connected to a corresponding second gate line of the second gate lines;
a second source electrode connected to the corresponding data line of the data lines; and
a second drain electrode connected to a second connection electrode branched from the second pixel electrode.

18. The electrophoresis display apparatus of claim 17, wherein each pixel further comprises a first channel area through which the first connection electrode passes, the second pixel electrode is disposed in an area except the first channel area, and the first channel area has a width larger than a width of the first connection electrode.

19. The electrophoresis display apparatus of claim 18, wherein the second pixel electrode comprises:
a first area having a band shape to surround the first pixel electrode;
a plurality of first branch portions extended from the first area toward an each vertex of the pixel electrode; and
a plurality of second branch portions extended from the first area toward each edges of the pixel electrode, wherein the second connection electrode is branched from the first branch portions or the second branch portions.

20. The electrophoresis display apparatus of claim 18, wherein the first and second pixel electrodes are formed to overlap with the storage electrode and the storage electrode has an area wider than a sum of an area of the first pixel electrode and an area of the second pixel electrode.
